(19) United States
(12) Patent Application Publication
(10) Pub. No.: US 2009/0003799 A1
(43) Pub. Date: Jan. 1, 2009

(54) Method for apparatus for reproducing image data

(75) Inventors: Wataru Inoha, Kanagawa-ken (JP); Tomohiro Azami, Kanagawa-ken (JP); Tsukimi Wakabayashi, Kanagawa-ken (JP); Takayuki Sugahara, Kanagawa-ken (JP); Shin Nakate, Kanagawa-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 12/213,341

(22) Filed: Jun. 18, 2008

(30) Foreign Application Priority Data
Jun. 29, 2007 (JP) 2007-171965
Jun. 29, 2007 (JP) 2007-171973

(51) Int. Cl. H04N 5/91; G06K 9/62; H04N 7/00

(52) U.S. Cl. 386/95; 386/46; 382/224; 386/E09.001

(57) ABSTRACT

Main image data pieces in a recording medium are classified into groups according to recording date and time. A digest image data piece is generated from a main image data piece or pieces in each of the groups. Each of the generated digest image data pieces represents a digest of contents of the corresponding main image data piece or pieces. Contents of the digest image data pieces are sequentially reproduced in response to user's command in an order accorded with the recording dates and times of the main image data pieces corresponding to the digest image data pieces.

### BACKGROUND OF THE INVENTION

1. Field of the Invention

This invention relates to a method and an apparatus for searching source image data pieces in a recording medium for desired one or ones before playing back the contents thereof.

2. Description of the Related Art

Japanese patent application publication number 2004-295231 discloses a method utilizing an index file indicating the photographing dates of respective image frames, that is, the dates when respective image frames were taken. In the method of Japanese application 2004-295231, the image frames are separated into a plurality of groups according to the intervals between the photographing dates indicated by the index file. A representative image is decided within each group. An image data file indicating the representative images is generated. The image data file is visualized by a display. Therefore, the representative images are indicated on the display while being arranged horizontally. The indicated representative images correspond to the groups, respectively.

In the method of Japanese application 2004-295231, a selection cursor is indicated on the display. When the selection cursor is moved to desired one among the indicated representative images (that is, desired one among the groups) and a decision button is operated, files of the image frames in the desired group are preferentially read and are then visualized by the display. Therefore, the image frames in the desired group are indicated on the display. The indicated image frames are arranged in a vertical line below the corresponding indicated representative image.

Japanese patent application publication number 11-032288/1999 discloses a video reproduction system in which main video programs are recorded on discs in casings, respectively. Product code words (reference marks) serving as IDs for the main video programs are printed on the related casings, respectively. There is another disc which stores short-story video signals representing digests of the main video programs respectively. Each of the short-story video signals contains the reference mark for the corresponding main video program.

In the system of Japanese application 11-032288/1999, the short-story video programs are sequentially reproduced from the digest disc, and the digests represented by the short-story video programs are sequentially indicated on a display. During the sequential indication of the digests on the display, a user actuates a selection key when the currently-indicated digest is desired one. Upon the actuation of the selection key, the reference mark in the currently-reproduced short-story video signal is detected. Among the casings of the main program discs, one is found which has a product code word matching the detected reference mark. The main video program is reproduced from the main program disc in the found casing, and is indicated on the display. In this way, the user can find desired one among the main video programs by monitoring the digests thereof. The desired main video program is indicated on the display.

In the system of Japanese application 11-032288/1999, the number of the short-story video signals increases as the number of the main video programs increases. When desired one is requested to be found among a large number of main video programs, it may be necessary to monitor a large number of short-story video signals.

In one trip, many scenes are shot by a video camera so that many video files being several tens of seconds to several minutes in play time are made. Signals representing digests of the respective video files can be generated. The digest signals can be used for finding desired one among the video files. In some cases, a user wishes to play back not only a desired video file but also other video files equal in shooting time zone to the desired video file. This user's wish can not be met by the system of Japanese application 11-032288/1999. In some other cases, a user wishes to play back not only a desired video file but also a digest of another video file equal in shooting day to the desired video file. This user's wish can not be met by the system of Japanese application 11-032288/1999.

### SUMMARY OF THE INVENTION

It is a first object of this invention to provide an apparatus for easily finding desired one among main video data pieces (main video data sequences, main video data blocks, or main video data files) through the use of digests of the contents of the main video data pieces even in cases where the number of the main video data pieces is large.

It is a second object of this invention to provide a method of easily finding desired one among main video data pieces through the use of digests of the contents of the main video data pieces even in cases where the number of the main video data pieces is large.

A first aspect of this invention provides an image data reproducing apparatus comprising first means for classifying main image data pieces in a recording medium into groups according to recording date and time; second means for generating a digest image data piece from a main image data piece or pieces in each of the groups, wherein each of the generated digest image data pieces represents a digest of contents of the corresponding main image data piece or pieces; and third means responsive to user's command for sequentially reproducing contents of the digest image data pieces, which are generated by the second means, in an order accorded with the recording dates and times of the main image data pieces corresponding to the digest image data pieces.

A second aspect of this invention provides an image data reproducing apparatus comprising first means for classifying main image data pieces in a recording medium into groups according to recording date and time; second means for generating a digest segment information piece designating a portion or portions of a main image data piece or pieces in each of the groups as a virtual digest image data piece; and third means responsive to user's command for sequentially reproducing contents of the portions designated by the digest segment information pieces generated by the second means to sequentially reproduce contents of the virtual digest image data pieces in an order accorded with the recording dates and times of the main image data pieces corresponding to the virtual digest image data pieces.

A third aspect of this invention is based on the first aspect thereof, and provides an image data reproducing apparatus further comprising fourth means for reproducing contents of one or ones of the main image data pieces, and fifth means responsive to user's command for replacing reproduction of contents of one of the digest image data pieces by the third means with reproduction of a main image data piece or pieces in a group corresponding to the one of the digest image data pieces by the fourth means, wherein the reproduction of the main image data pieces is in an order accorded with the recording dates and times thereof.

A fourth aspect of this invention is based on the first aspect thereof, and provides an image data reproducing apparatus further comprising fourth means for reproducing contents of one of the main image data pieces, and fifth means responsive to user's command for replacing reproduction of one of the main image data pieces by the fourth means with reproduction of a digest image data piece corresponding to a group to which the one of the main image data pieces belongs, and other digest image data pieces by the third means, wherein the reproduction of the digest image data pieces is in an order accorded with the recording dates and times of the main image data pieces corresponding to the digest image data pieces.

A fifth aspect of this invention provides a method of reproducing image data. The method comprises the steps of classifying main image data pieces in a recording medium into groups according to recording date and time; generating a digest image data piece from a main image data piece or pieces in each of the groups, wherein each of the generated digest image data piece represents a digest of contents of the corresponding main image data piece or pieces; and responsive to user's command, sequentially reproducing contents of the digest image data pieces in an order accorded with the recording dates and times of the main image data pieces corresponding to the digest image data pieces.

A sixth aspect of this invention provides a method of reproducing image data. The method comprises the steps of classifying main image data pieces in a recording medium into groups according to recording date and time; generating a digest segment information piece designating a portion or portions of a main image data piece or pieces in each of the groups as a virtual digest image data piece; and responsive to user's command, sequentially reproducing contents of the portions designated by the generated digest segment information pieces to sequentially reproduce contents of the virtual digest image data pieces in an order accorded with the recording dates and times of the main image data pieces corresponding to the virtual digest image data pieces.

A seventh aspect of this invention provides an image data reproducing apparatus comprising first means for reproducing first image data; second means for reproducing second image data containing link information providing a link to the first image data; and third means for making a switch from the reproduction of the second image data by the second means to the reproduction of the first image data by the first means in response to the link information.

An eighth aspect of this invention is based on the seventh aspect thereof, and provides an image data reproducing apparatus wherein the link information represents a term for which the link information is effective, and an ID number of the first image data or an ID number of one among groups of pieces of the first image data, and wherein the link information contains button information, and further comprising a display for indicating a button in accordance with the button information, means for allowing a user to select the button indicated by the display, and means provided in the third means for making a switch from the reproduction of the second image data by the second means to the reproduction of the first image data having the ID number represented by the link information or a piece of the first image data in a group having the ID number represented by the link information in cases where the user selects the button during the term represented by the link information.

A ninth aspect of this invention is based on the eighth aspect thereof, and provides an image data reproducing apparatus wherein the link information contains compulsory information representing one of (1) an ID number of the first image data, (2) an ID number of one among groups of pieces of the first image data, and (3) an ID number of one among pieces of the second image data, and further comprising means for making a switch from the reproduction of one among pieces of the second image data by the second means to reproduction of one of (1) the first image data having the ID number represented by the compulsory information, (2) a piece of the first image data in a group having the ID number represented by the compulsory information, and (3) a piece of the second image data which has the ID number represented by the compulsory information in cases where the user does not select the button during the term represented by the link information.

A tenth aspect of this invention provides a method of reproducing image data. The method comprises the steps of a) reproducing first image data; b) reproducing second image data containing link information providing a link to the first image data; and c) making a switch from the reproduction of the second image data by the step b) to the reproduction of the first image data by the step a) in response to the link information.

An eleventh aspect of this invention is based on the tenth aspect thereof, and provides a method wherein the link information represents a term for which the link information is effective, and an ID number of the first image data or an ID number of one among groups of pieces of the first image data, and wherein the link information contains button information, and further comprising the steps of enabling a display to indicate a button in accordance with the button information, allowing a user to select the button indicated by the display, and making a switch from the reproduction of the second image data by the step b) to the reproduction of the first image data having the ID number represented by the link information or a piece of the first image data in a group having the ID number represented by the link information in cases where the user selects the button during the term represented by the link information.

A twelfth aspect of this invention is based on the eleventh aspect thereof, and provides a method wherein the link information contains compulsory information representing one of (1) an ID number of the first image data, (2) an ID number of one among groups of pieces of the first image data, and (3) an ID number of one among pieces of the second image data, and further comprising the step of making a switch from the reproduction of one among pieces of the second image data by the step b) to reproduction of one of (1) the first image data having the ID number represented by the compulsory information, (2) a piece of the first image data in a group having the ID number represented by the compulsory information, and (3) a piece of the second image data which has the ID number represented by the compulsory information in cases where the user does not select the button during the term represented by the link information.

This invention has the advantage that a user can easily and promptly know the contents of each of groups of main image data pieces in a recording medium.

### BRIEF DESCRIPTION OF THE DRAWINGS

FIG. 1 is a diagram of an image data reproducing apparatus according to a first embodiment of this invention.

FIG. 2 is a diagram of an example of main image data pieces, groups of the main image data pieces, and digest image data pieces in the first embodiment of this invention.

FIG. 3 is a diagram of a first example of main image data pieces, portions extracted therefrom, and a digest data piece generated by connecting the extracted portions.

FIG. 4 is a diagram of a second example of main image data pieces, portions extracted therefrom, and a digest image data piece generated by connecting the extracted portions.

FIG. 5 is a diagram of the structure of a recording area in a recording medium in FIG. 1.

FIG. 6 is a diagram of management information pieces in a memory within a reproduction controlling section in FIG. 1.

FIG. 7 is a diagram of the structure of management information in the recording medium in FIG. 1.

FIG. 8 is a diagram of the relation among digest image data pieces, management information pieces, and groups of main image data pieces in the first embodiment of this invention.

FIG. 9 is a block diagram of the image data reproducing apparatus in the first embodiment of this invention.

FIG. 10 is a flowchart of a segment of a control program for a computer in FIG. 9.

FIG. 11 is a diagram of an image data reproducing apparatus according to a second embodiment of this invention.

FIG. 12 is a diagram of an example of a digest data playlist in the second embodiment of this invention.

FIG. 13 is a flowchart of a first segment of a control program for a computer in a sixth embodiment of this invention.

FIG. 14 is a flowchart of a second segment of the control program for the computer in the sixth embodiment of this invention.

FIG. 15 is a diagram of an image data reproducing apparatus according to a seventh embodiment of this invention.

FIG. 16 is a diagram of an example of main image data pieces, groups of the main image data pieces, and digest image data pieces in the seventh embodiment of this invention.

FIG. 17 is a diagram of the structure of a digest image data piece in the seventh embodiment of this invention.

FIG. 18 is a diagram of an example of a digest picture in the seventh embodiment of this invention.

FIG. 19 is a flowchart of a segment of a control program for a computer in a reproduction controlling section in FIG. 15.

FIG. 20 is a diagram of an image data reproducing apparatus according to an eighth embodiment of this invention.

FIG. 21 is a flowchart of a segment of a control program for a computer in a ninth embodiment of this invention.

### DETAILED DESCRIPTION OF THE INVENTION

### First Embodiment

Each main image data piece represents pictures taken by, for example, a video camera during every shooting. Each main image data piece may have sound-representing components and other-information-representing components in addition to picture-representing components. The pictures represented by each main image data piece are moving pictures, still pictures, or a mixture of moving pictures and still pictures. Each main image data piece is a main image data sequence, a main image data block, or a main image data file.

Digest image data pieces correspond to main image data pieces, respectively. Each digest image data piece represents a digest of pictures represented by the corresponding main image data piece. Each digest image data piece may have sound-representing components and other-information-representing components in addition to picture-representing components. The picture digest represented by each digest image data piece means a digest of moving pictures, a digest of still pictures, or a digest of a mixture of moving pictures and still pictures. Each digest image data piece is a digest image data sequence, a digest image data block, or a digest image data file.

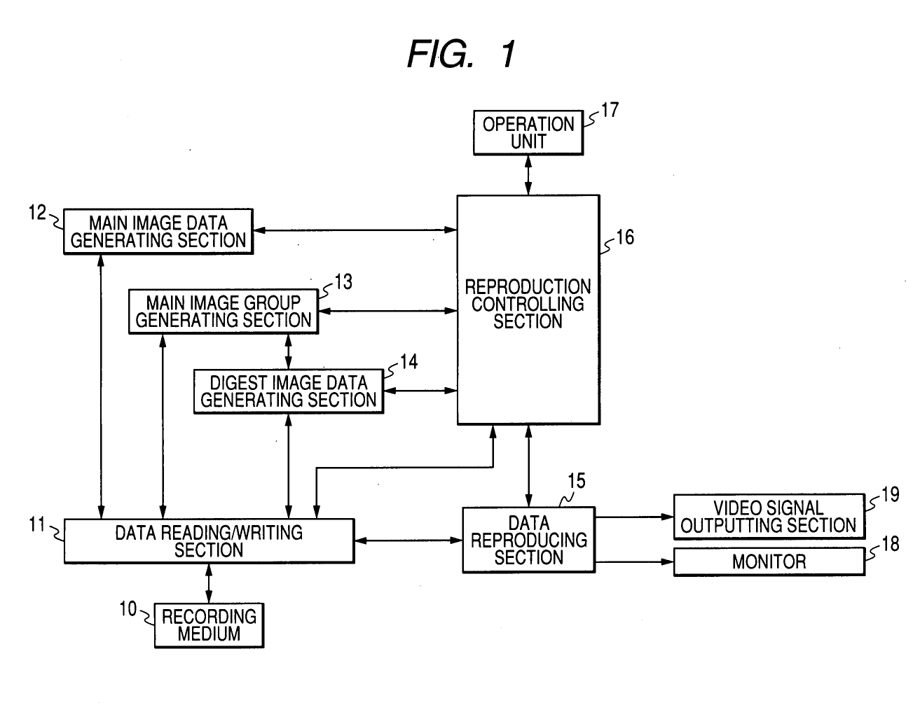

FIG. 1 shows an image data reproducing apparatus according to a first embodiment of this invention. It should be noted that a portion of FIG. 1 shows the operation of the image data reproducing apparatus rather than the hardware structure thereof. The image data reproducing apparatus may be provided in a video camera.

With reference to FIG. 1, there are a recording medium 10, a data reading/writing section 11, a main image data generating section 12, a main image group generating section 13, a digest image data generating section 14, a data reproducing section 15, a reproduction controlling section 16, an operation unit 17, a monitor (a display device) 18, and a video signal outputting section 19.

Preferably, the data reading/writing section 11 includes a drive for the recording medium 10. The data reading/writing section 11 operates to read data from the recording medium 10 and write data thereon. There is an image capturing section or a camera section (not shown in FIG. 1). During every shooting, the camera section repetitively captures an image of a subject or a target scene, and generates a video data piece representing a stream of moving pictures or a set of still pictures formed by the respective captured images. The main image data generating section 12 receives each video data piece generated by the camera section. The main image data generating section 12 encodes the received video data piece to generate a main image data piece (a main image data sequence, a main image data block, or a main image data file). The main image data generating section 12 sends the main image data piece to the data reading/writing section 11. The data reading/writing section 11 records the main image data piece on the recording medium 10.

For each main image data piece generated by the main image data generating section 12 and recorded on the recording medium 10, the main image data generating section 12 obtains or generates a management information piece representing the name and type of the recording medium 10, and the ID or name (file name), logical address (block address), recording date and time, shooting date and time, play time, and image quality of the main image data piece. The main image data generating section 12 feeds the management information piece to the reproduction controlling section 16. The main image data generating section 12 controls the data reading/writing section 11 to record the management information piece on the recording medium 10. Preferably, the main image data generating section 12 is informed of the present date and time by a calendar and a clock.

The main image group generating section 13 accesses management information pieces in the reproduction controlling section 16 or accesses management information pieces in the recording medium 10 through the data reading/writing section 11, and thereby detects the shooting or recording date and time of each of the main image data pieces in the recording medium 10. The main image group generating section 13 classifies the main image data pieces into groups according to shooting or recording date and time. The main image group generating section 13 generates a management information piece representing which of the groups each of the main image data pieces belongs to. The main image group generating section 13 feeds the generated management information piece to the digest image data generating section 14 and the reproduction controlling section 16. The main image group generating section 13 controls the data reading/writing section 11 to record the management information piece on the recording medium 10.

The digest image data generating section 14 responds to each management information piece fed from the main image group generating section 13 and representing which of the groups a related main image data piece belongs to. For each group given by the main image group generating section 13, the digest image data generating section 14 accesses an in-group main image data piece or pieces in the recording medium 10 through the data reading/writing section 11. For each group, the digest image data generating section 14 produces a digest image data piece from the accessed main image data piece or pieces. The digest image data generating section 14 records the digest image data pieces on the recording medium 10 through the data reading/writing section 11 on a group-by-group basis.

For each digest image data piece generated by the digest image data generating section 14 and recorded on the recording medium 10, the digest image data generating section 14 obtains or generates a management information piece representing the name and type of the recording medium 10, and the ID or name (file name), logical address (block address), recording date and time, play time, and image quality of the digest image data piece, and which of the groups given by the main image group generating section 13 the digest image data piece belongs to. The digest image data generating section 14 feeds the management information piece to the reproduction controlling section 16. The digest image data generating section 14 controls the data reading/writing section 11 to record the management information piece on the recording medium 10. Preferably, the digest image data generating section 14 is informed of the present date and time by the calendar and the clock.

The data reproducing section 15 can read each main image data piece or each digest image data piece from the recording medium 10 through the data reading/writing section 11. The data reproducing section 15 decodes the read main image data piece or digest image data piece into a video signal. The data reproducing section 15 feeds the video signal to the monitor 18. The monitor 18 visualizes the video signal. In other words, the monitor 18 indicates the contents of the video signal. Thus, the contents of the read main image data piece or digest image data piece are played back (reproduced). In addition, the data reproducing section 15 feeds the video signal to an external display device (not shown) through the video signal outputting section 19. The external display device visualizes the video signal. In other words, the external display device indicates the contents of the video signal. Thus, the contents of the read main image data piece or digest image data piece are played back (reproduced).

The reproduction controlling section 16 controls the data reading/writing section 11 and the data reproducing section 15 to implement the start, stop, pause, fast feed, and fast rewind of the playback or reproduction of each main image data piece or each digest image data piece. The operation unit 17 can be actuated by a user. The operation unit 17 generates a command signal in accordance with the actuation thereof by the user. The command signal denotes, for example, user's request. The operation unit 17 outputs the command signal to the reproduction controlling section 16. The reproduction controlling section 16 responds to the command signal. Specifically, the command signal is designed so that a switch between the reproduction of main image data pieces and the reproduction of digest image data pieces can be provided in accordance with user's request, and that the reproduction of each main or digest image data piece can be controlled in accordance with user's request.

Preferably, the recording medium 10 is a hard disc or a memory fixed to or removable from the body of the image data reproducing apparatus. Alternatively, the recording medium 10 may be an optical disc such as a DVD or a BD. There may be a first recording medium exclusively for storing main image data pieces and a second recording medium exclusively for storing digest image data pieces.

The data reading/writing section 11 includes a magnetic head when the recording medium 10 is a hard disc. The data reading/writing section 11 includes an optical pickup when the recording medium 10 is an optical disc. The data reading/writing section 11 includes circuits designed to implement data modulation and demodulation for the writing and reading of a signal into and from the recording medium 10. In the case where the recording medium 10 is provided as external one with respect to the image data reproducing apparatus, the data reading/writing section 11 includes an interface for sending and receiving data to and from the recording medium 10 via an accessing device for the recording medium 10.

Preferably, main image data pieces and digest image data pieces conform to a same encoding system such as an MPEG2 system. In this case, the data reproducing section 15 includes a single-type decoder. Main image data pieces and digest image data pieces may conform to different encoding systems. In this case, the data reproducing section 15 includes a first decoder designed for main image data pieces and a second decoder designed for digest image data pieces. At least two main image data pieces or digest image data pieces may be simultaneously reproduced and visualized. In this case, the data reproducing section 15 includes at least two decoders.

As previously mentioned, the operation unit 17 generates a command signal in accordance with the actuation thereof by the user. The generated command signal corresponds to, for example, user's request for the start of reproduction (playback) of a target main or digest image data piece. The operation unit 17 outputs the command signal to the reproduction controlling section 16. The reproduction controlling section 16 responds to the command signal. In the case where the command signal corresponds to user's request for the start of reproduction of a target main or digest image data piece, the reproduction controlling section 16 controls the data reading/writing section 11 to transfer the target main or digest image data piece from the recording medium 10 to the data reproducing section 15. Furthermore, the reproduction controlling section 16 controls the data reproducing section 15 to decode the target main or digest image data piece.

Preferably, the operation unit 17 has buttons assigned to different command types such as reproduction start (playback start) and reproduction stop (playback stop).

The image data reproducing apparatus may be provided with a GUI (Graphical User Interface) associated with the operation unit 17, the monitor 18, and the external display device. In this case, the operation unit 17 has cross keys and arrow buttons for up, down, left, and right movements, and a decision button. The monitor 18 or the external display device is controlled to indicate operation selecting buttons (command-type selecting buttons) and a list of main image data pieces or digest image data pieces in the recording medium 10. The indicated operation selecting buttons are associated with the keys and the buttons on the operation unit 17. The user can select one from the listed main or digest image data pieces by actuating the operation unit 17.

The operation unit 17 may include a keyboard and a mouse. The operation unit 17 may include an infrared remote control device having a transmitter provided with keys, and an interface for receiving an infrared signal from the transmitter.

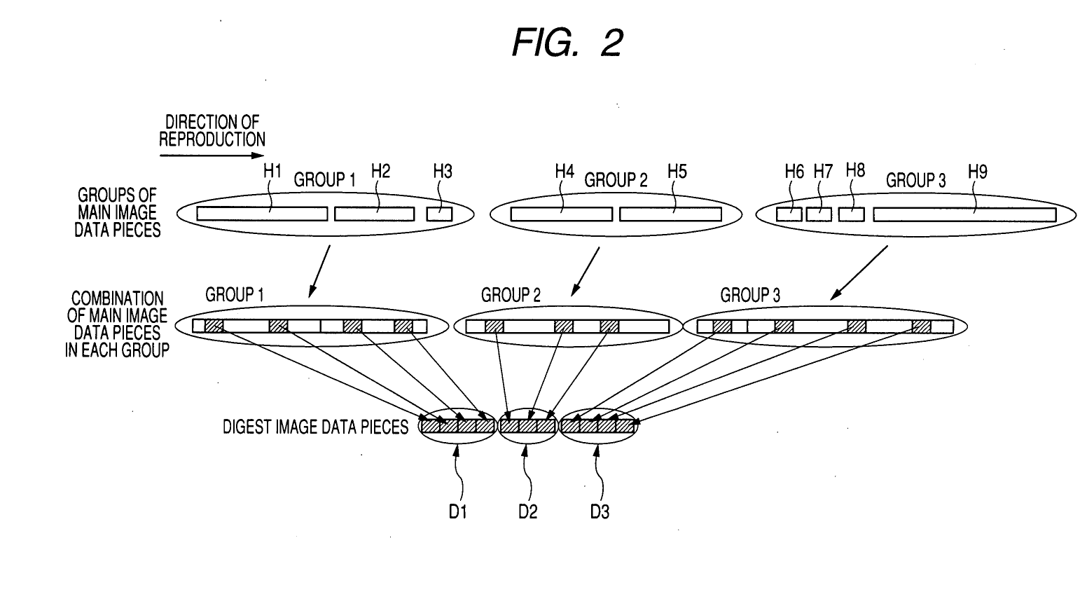

With reference to FIG. 2, there are main image data pieces H1-H9 generated by the main image data generating section 12. The main image data pieces H1-H9 are arranged in the order of reproduction. In FIG. 2, the horizontal dimension of a rectangle denoting each of the main image data pieces H1-H9 represents a play time thereof. Furthermore, the spaces between the rectangles for the main image data pieces H1-H9 represent the intervals in shooting or recording date and time between the main image data pieces H1-H9.

The main image group generating section 13 implements the grouping of the main image data pieces H1-H9 according to the intervals in shooting or recording date and time therebetween. Specifically, the main image group generating section 13 compares each of the intervals in shooting or recording date and time between the main image data pieces H1-H9 with a prescribed threshold value, and implements the grouping of the main image data pieces H1-H9 in accordance with the comparison results. The prescribed threshold value is equal to, for example, 10 minutes, 20 minutes, 1 day, 5 days, or 1 week. In FIG. 2, the intervals in shooting or recording date and time between the main image data pieces H1, H2, and H3 are smaller than the prescribed threshold value so that they are placed in one group “1”. The interval in shooting or recording date and time between the main image data pieces H3 and H4 is equal to or greater than the prescribed threshold value so that the main image data piece H4 is placed in a group “2” different from the group “1”. The interval in shooting or recording date and time between the main image data pieces H4 and H5 is smaller than the prescribed threshold value so that the main image data piece H5 is placed in the group “2” also. The interval in shooting or recording date and time between the main image data pieces H5 and H6 is equal to or greater than the prescribed threshold value so that the main image data piece H6 is placed in a group “3” different from the group “2”. The intervals in shooting or recording date and time between the main image data pieces H6, H7, H8, and H9 are smaller than the prescribed threshold value so that the main image data pieces H7, H8, and H9 are placed in the group “3” also.

In the case where the interval in shooting or recording date and time between two successive main image data pieces is equal to or greater than the prescribed threshold value, the main image data pieces are considered to be generated during different events such as a trip and an athletic meeting respectively. Thus, in this case, the main image group generating section 13 places the main image data pieces in different groups respectively. In FIG. 2, the main image data pieces H1, H2, and H3 are placed in the group “1”. The main image data pieces H4 and H5 are placed in the group “2”. The main image data pieces H6, H7, H8, and H9 are placed in the group “3”. Usually, main image data pieces in one group are generated during a same event, and are close or similar to each other in shooting date and time.

In the case where the prescribed threshold value is equal to 10 or 20 minutes, main image data pieces can be classified into groups corresponding to respective tourist spots visited during a same trip or respective items in a same athletic meeting.

Main image data pieces in a specified time range for shooting or recording date and time may be placed in one group. In the case where a main image data piece having a specified play time is recorded on the recording medium 10, the present main image data piece may be placed in a group while a main image data piece or pieces preceding the present image data piece may be placed in another group. Furthermore, the present main image data piece may be placed in a group while a main image data piece or pieces following the present image data piece may be placed in another group.

Preferably, information representing the prescribed threshold value is stored in the reproduction controlling section 16. The main image group generating section 13 receives, from the reproduction controlling section 16, the information representing the prescribed threshold value.

The prescribed threshold value may be selected by the user on a GUI basis such that one can be chosen, by actuating the operation unit 17, from candidate values indicated on the monitor 18. Alternatively, the prescribed threshold value may be directly set by inputting numerals through the operation unit 17.

With reference to FIG. 2, for every group, the digest image data generating section 14 serially connects and combines in-group main image data pieces into one image data stream. During the connecting and combining, the main image data pieces may be re-encoded according to the encoding system therefor. For every group, the digest image data generating section 14 extracts portions from the image data stream (portions from the in-group main image data pieces), and connects the extracted portions to generate a digest image data piece.

In FIG. 2, the digest image data generating section 14 extracts portions from the image data stream (portions from the main image data pieces H1, H2, and H3) in the group “1”, and connects the extracted portions to generate a digest image data piece D1 corresponding to the group “1”. The digest image data generating section 14 extracts portions from the image data stream (portions from the main image data pieces H4 and H5) in the group “2”, and connects the extracted portions to generate a digest image data piece D2 corresponding to the group “2”. The digest image data generating section 14 extracts portions from the image data stream (portions from the main image data pieces H6, H7, H8, and H9) in the group “3”, and connects the extracted portions to generate a digest image data piece D3 corresponding to the group “3”.

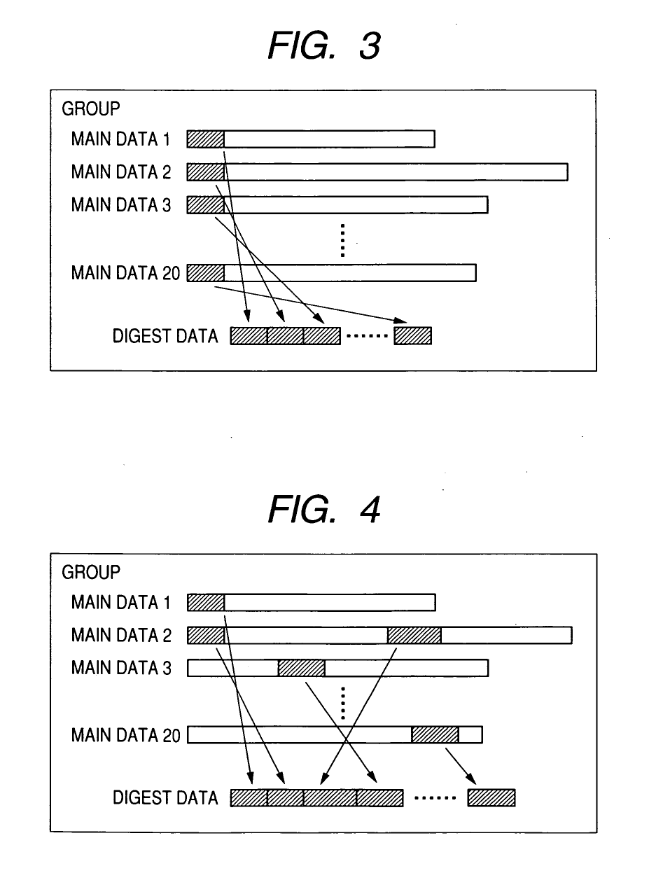

The method of generating digest image data pieces by the digest image data generating section 14 is one of the following different types. FIG. 3 relates to the digest generating method of a first type, in which 3-second head portions are extracted from main image data pieces “1”, “2”, “3”, . . . , “20” in a same group. The extracted portions are connected to generate a 60-second digest image data piece for the group. FIG. 4 relates to the digest generating method of a second type, in which portions are extracted from main image data pieces “1”, “2”, “3”, . . . , “20” in a same group. The portions to be extracted occupy arbitrary places in the main image data pieces “1”, “2”, “3”, . . . , “20”. The play time of each extracted portion depends on the play time of the related main image data piece. Two or more portions may be extracted from one main image data piece. The extracted portions are connected to generate a digest image data piece for the group.

In the digest generating method of the first or second type, no portion may be extracted from at least one main image data piece. Plural portions may be extracted from one main image data piece. In the case of a main image data piece having a play time shorter than a predetermined small value, a portion having a play time shorter than 3 seconds may be extracted therefrom. In the case of a main image data piece having a play time longer than a predetermined large value, a portion having a play time longer than 3 seconds may be extracted therefrom. Different-time-length portions may be extracted from main image data pieces, respectively. Fixed-time-length portions temporally spaced from the heads of main image data pieces at equal time intervals may be extracted from the main image data pieces. No portion may be extracted from a main image data piece having a play time equal to or shorter than a predetermined reference value. In the case of main image data pieces conforming to a compressively encoding system such as an MPEG system, portions to be extracted therefrom may be measured in units depending on the compressively encoding system. The units correspond to, for example, several frames or several GOPs.

For main image data pieces conforming to a compressively encoding system such as an MPEG system, it is preferable to re-encode several-GOP ends of portions extracted from the main image data pieces. The extracted portions having the re-encoded ends are connected to form a digest image data piece. In this case, the re-encoding allows a picture and a sound represented by the digest image data piece to be properly reproduced at a time point corresponding to each of the boundaries between the connected extracted portions. Alternatively, the whole of the digest image data piece may be re-encoded.

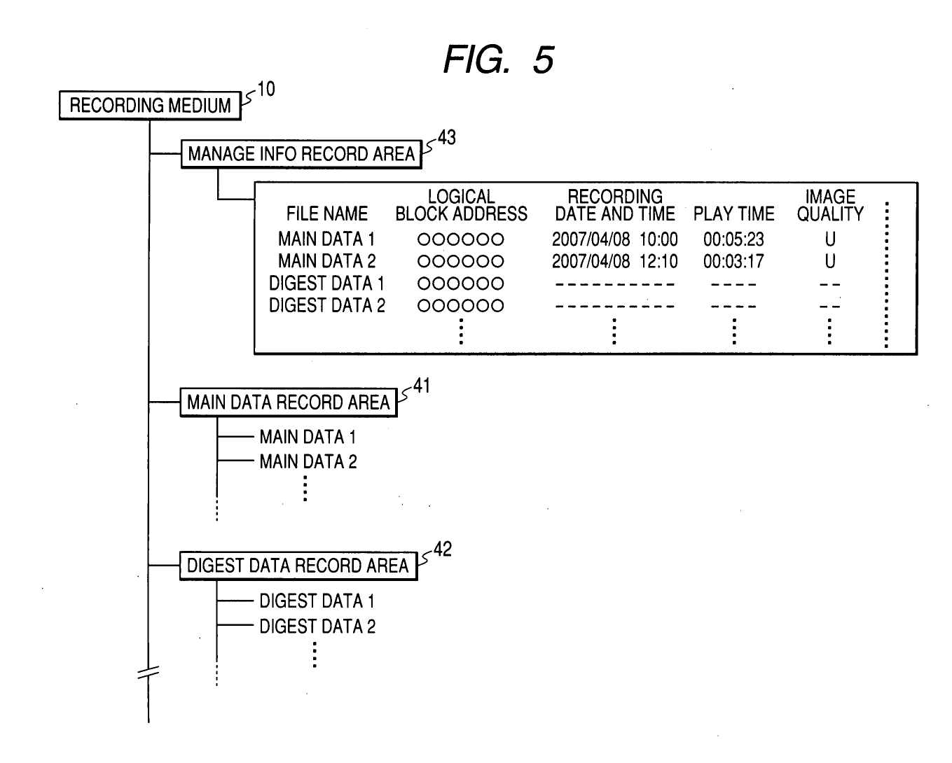

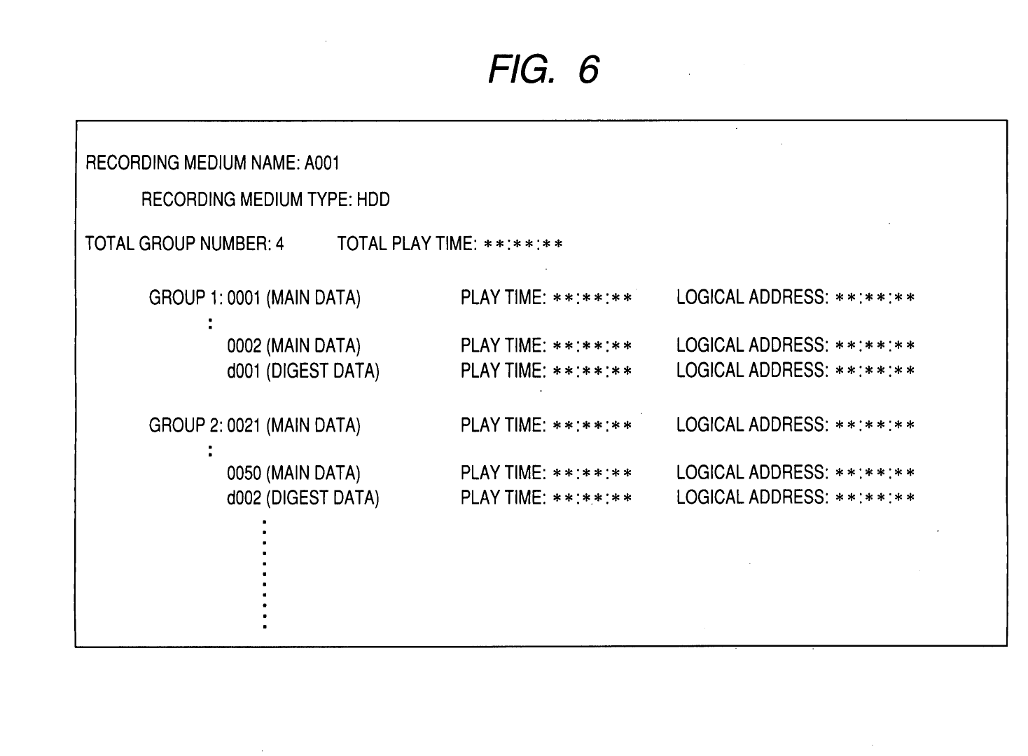

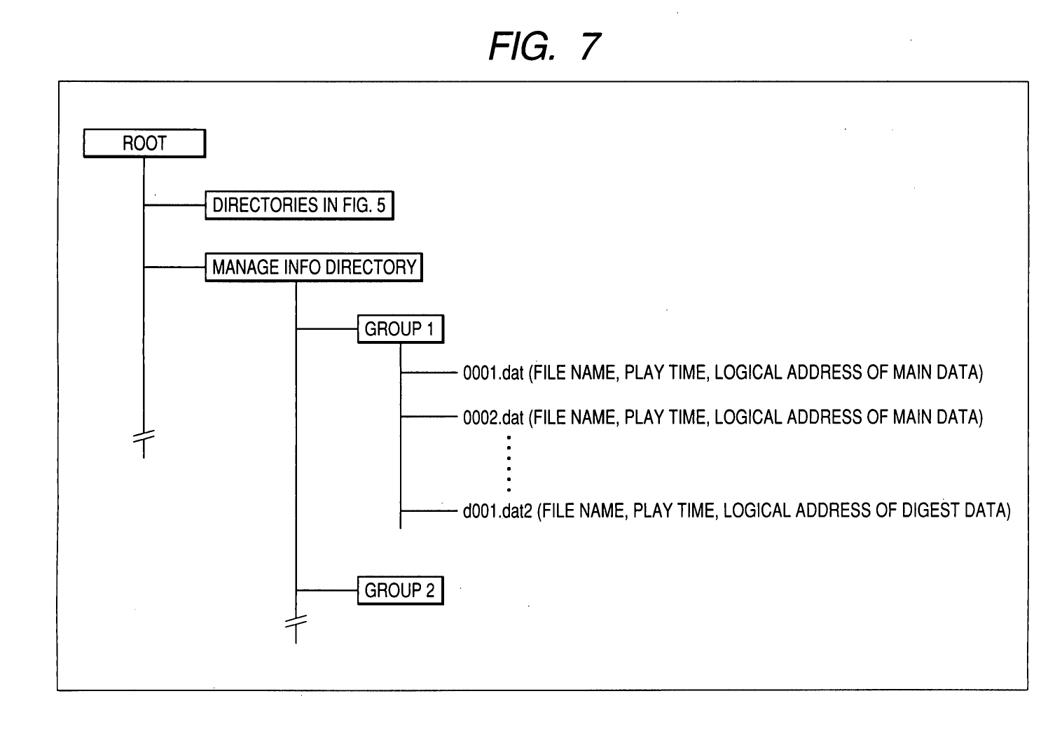

As shown in FIG. 5, the recording medium 10 has an area 41 for storing main image data pieces generated by the main image data generating section 12, an area 42 for storing digest image data pieces generated by the digest image data generating section 14, and an area 43 for storing management information generated by the reproduction controlling section 16. The management information represents the logical address (block address), recording date and time, shooting date and time, play time, and image quality of each of the main image data pieces and the digest image data pieces in the recording medium 10.

For each main image data piece generated by the main image data generating section 12, the reproduction controlling section 16 receives the related management information piece from the main image data generating section 12 and stores the received management information piece into an internal memory. The reproduction controlling section 16 computes the total play time of the main image data pieces in the recording medium 10 by referring to the management information pieces received from the main image data generating section 12. The reproduction controlling section 16 generates a management information piece representing the computed total play time, and stores the generated management information piece into the internal memory. For each digest image data piece generated by the digest image data generating section 14, the reproduction controlling section 16 receives the related management information piece from the digest image data generating section 14 and stores the received management information piece into the internal memory. Furthermore, the reproduction controlling section 16 receives the management information piece from the main image group generating section 13 and stores the received management information piece into the internal memory.

The user can input information into the reproduction controlling section 16 by actuating the operation unit 17. The inputted information represents the genre of the contents of each main image data piece, the name of a person who makes the recording of each main image data piece or the shooting to generate each main image data piece, and the place where the recording or the shooting is done. The reproduction controlling section 16 generates management information pieces from the inputted information, and stores the generated management information pieces into the internal memory.

As shown in FIG. 6, the management information pieces in the internal memory within the reproduction controlling section 16 are separated into groups corresponding to the respective groups provided by the main image group generating section 13. The first portion of an array of the management information pieces in the internal memory represents the name “A001” of the recording medium 10. The second portion of the array represents the type “HDD” of the recording medium 10. The third portion of the array represents the number “4” of groups given by the main image group generating section 13. The fourth portion of the array represents the total play time of the main image data pieces in the recording medium 10. The fifth and later portions of the array are separated into groups corresponding to the respective groups given by the main image group generating section 13. In each of the groups, management information pieces represent the ID numbers (file names), play times, and logical addresses (block addresses) of related main image data pieces and a related digest image data piece while the represented items are in relation or correspondence with each other.

The reproduction controlling section 16 obtains management information from the management information pieces in the internal memory. The reproduction controlling section 16 controls the data reading/writing section 11 to record the obtained management information in the area 43 of the recording medium 10.

As shown in FIG. 7, the management information in the area 43 of the recording medium 10 is of a tree structure. Specifically, the management information is divided into segments corresponding to the respective groups given by the main image group generating section 13. Each of the segments represents the ID numbers (file names), play times, and logical addresses (block addresses) of related main image data pieces and a related digest image data piece.

The reproduction controlling section 16 may be informed of the present date and time by the calendar and the clock. By referring to the present date and time and communicating with the main image data generating section 12, the reproduction controlling section 16 may detect the shooting or recording date and time of each main image data piece and generate an attribute information piece representative of the detected recording date and time. Preferably, the reproduction controlling section 16 stores the attribute information pieces in the internal memory, and manages the stored attribute information pieces. Each attribute information piece may be recorded on the recording medium 10 via the data reading/writing section 11 together with the related main image data piece. Preferably, the attribute information pieces are stored in the area 43 of the recording medium 10. Management information pieces representing the correspondence relation between the attribute information pieces and the main image data pieces, the names of the main image data pieces, and the logical and physical on-recording-medium addresses of the main image data pieces may also be stored in the area 43 of the recording medium 10.

The image data reproducing apparatus operates as follows. It is assumed that the recording medium 10 stores main image data pieces generated by the main image data generating section 12, and that the internal memory in the reproduction controlling section 16 stores management information pieces for the respective main image data pieces recorded on the recording medium 10. Each management information piece represents, for example, the ID number, recording date and time, shooting date and time, and play time of the related main image data piece, the genre of the contents of the related main image data piece, the name of a person who makes the recording of the related main image data piece or the shooting to generate the related main image data piece, and the place where the recording or the shooting is done.

The user actuates the operation unit 17 to input, into the image data reproducing apparatus, a command to start the reproduction (playback) of digest image data pieces. The reproduction controlling section 16 receives the inputted command, and responds thereto. Specifically, the reproduction controlling section 16 instructs the main image group generating section 13 to implement grouping in response to the digest reproduction start command. Then, the main image group generating section 13 groups the main image data pieces in the recording medium 10.

Preferably, the operation unit 17 has a digest reproduction start button. The user can input the digest reproduction start command into the image data reproducing apparatus by actuating the digest reproduction start button. Alternatively, a GUI-based button for digest reproduction may be indicated on the monitor 18. In this case, the user can input the digest reproduction start command into the image data reproducing apparatus by pointing to the GUI-based button.

The main image group generating section 13 accesses the management information pieces in the reproduction controlling section 16 or accesses the management information pieces in the recording medium 10 through the data reading/writing section 11 to detect the shooting or recording date and time of each of the main image data pieces and calculate the intervals in shooting or recording date and time between the main image data pieces. The main image group generating section 13 classifies the main image data pieces into groups according to the calculated intervals in shooting or recording date and time therebetween. The main image group generating section 13 generates a management information piece representing which of the groups each of the main image data pieces belongs to. The main image group generating section 13 feeds the generated management information piece to the reproduction controlling section 16. The main image group generating section 13 informs the reproduction controlling section 16 when the grouping is completed.

After the grouping is completed, the reproduction controlling section 16 instructs the digest image data generating section 14 to generate digest image data pieces. Then, the digest image data generating section 14 generates a digest image data piece for each of the groups given by the main image group generating section 13 before recording the generated digest image data piece on the recording medium 10 through the data reading/writing section 11. In addition, the digest image data generating section 14 generates a management information piece for each digest image data piece recorded on the recording medium 10. The generated management information piece represents the ID or name (file name), play time, and logical address (block address) of the related digest image data piece, and which of the groups given by the main image group generating section 13 the related digest image data piece belongs to. The digest image data generating section 14 feeds each management information piece to the reproduction controlling section 16.

The management information pieces generated by the main image group generating section 13 and the digest image data generating section 14 represent which of the groups each of the main image data pieces and the digest image data pieces belongs to. The management information pieces are stored in the internal memory within the reproduction controlling section 16. According to the management information pieces in FIG. 6, a group “1” contains main image data pieces having names of “0001” to “0020” and a digest image data piece having a name of “d001”. The management information pieces may further represent the logical address, physical address, logical on-recording-medium position, physical on-recording-medium position, and play time of each of the main image data pieces and the digest image data pieces. In the case where the main image data pieces and the digest image data pieces are recorded over a plurality of recording mediums, it is preferable that the management information pieces further represent the ID or name of each of the recording mediums and which of the recording mediums each of the main image data pieces and the digest image data pieces is recorded on.

The management information pieces generated by the main image group generating section 13 and the digest image data generating section 14 are recorded on the recording medium 10 through the data reading/writing section 11. As shown in FIG. 7, the recording medium 10 is provided with a route directory under which directories assigned to the respective groups given by the main image group generating section 13 are located. Files are generated from the management information pieces. The files are placed under the group-corresponding directories in a manner such that files under each group-corresponding directory represent the names, play times, and logical addresses of main image data pieces and a digest image data piece in the corresponding group. Preferably, an extension for the main image data pieces differs from that for the digest image data pieces. In this case, it is easy to discriminate between the main image data pieces and the digest image data pieces.

Preferably, the digest image data generating section 14 and the data reading/writing section 11 cooperate to record the digest image data pieces on the recording medium 10 while being controlled by the reproduction controlling section 16. The reproduction controlling section 16 writes the management data pieces from the main image group generating section 13 and the digest image data generating section 14 into the internal memory. As previously mentioned, the internal memory in the reproduction controlling section 16 also stores the management information pieces for the respective main image data pieces. The management information pieces in the internal memory within the reproduction controlling section 16 are arranged so as to clearly represent the relation or correspondence among the groups, the main image data pieces, and the digest image data pieces (see FIG. 6). The reproduction controlling section 16 controls the data reading/writing section 11 to record the management information pieces on the recording medium 10. The management information pieces in the recording medium 10 are arranged so as to clearly represent the relation or correspondence among the groups, the main image data pieces, and the digest image data pieces (see FIG. 7).

Each digest image data piece may have a header storing a group-related information piece (a management information piece) representing which of the groups the digest image data piece belongs to. Similarly, each main image data piece may have a header storing a group-related information piece (a management information piece) representing which of the groups the main image data piece belongs to. In the case of a main or digest image data piece of an MPEG system, a user data area in a GOP layer or a picture layer is used as a header. Group-related information may be watermark information embedded in each main or digest image data piece. In this case, the group-related information can be in the main or digest image data piece even when the main or digest image data piece has neither a header nor a user data area. Preferably, the reproduction controlling section 16 accesses each main or digest image data piece in the recording medium 10 through the data reading/writing section 11, thereby writing a related group-related information piece (a related management data piece) in the accessed main or digest image data piece.

After the management information pieces are written into the internal memory within the reproduction controlling section 16 and are recorded on the recording medium 10, the reproduction controlling section 16 controls the data reading/writing section 11 to sequentially read the digest image data pieces from the recording medium 10 by referring to the management information pieces in the internal memory. The data reading/writing section 11 sequentially passes the digest image data pieces to the data reproducing section 15. The reproduction controlling section 16 controls the data reproducing section 15 to decode each digest image data piece into a video signal. The data reproducing section 15 sequentially feeds the video signals to the monitor 18. In addition, the data reproducing section 15 sequentially feeds the video signals to the external display device through the video signal outputting section 19. The monitor 18 and the external display device sequentially visualize the video signals. In other words, the monitor 18 and the external display device successively indicate pictures represented by the original digest image data pieces. Thus, the contents of the digest image data pieces are sequentially reproduced (played back). The sequential reproduction of the contents of the digest image data pieces is in a group-based order decided by the shooting or recording dates and times of main image data pieces in each of the groups. For example, the sequential reproduction is along the direction from the digest image data piece in the group oldest with respect to the shooting or recording dates and times of the main image data pieces therein toward the digest image data piece in the group newest with respect to the shooting or recording dates and times of the main image data pieces therein. In this case, the sequential reproduction starts from the digest image data piece in the oldest group, and ends at the digest image data piece in the newest group. The sequential reproduction of the contents of the digest image data pieces may be repeated.

Pictures represented by the digest image data pieces are presented to the user through the monitor 18 and the external display device. By watching the presented digest pictures, the user can find desired one among the digest image data pieces. At this time, the user can command the image data reproducing apparatus to play back (reproduce) the main image data pieces corresponding to the found digest image data piece. Generally, the main image data pieces corresponding to the found digest image data piece are desired ones. Accordingly, the reproduction of the desired main image data pieces is commanded.

When the currently presented digest picture is desired one, the user actuates the operation unit 17 to input, into the image data reproducing apparatus, a command to replace the reproduction of the digest image data pieces with the reproduction of desired main image data pieces. The reproduction controlling section 16 receives the inputted command, and responds thereto. Specifically, the reproduction controlling section 16 refers to the management information pieces in the internal memory, and thereby identifies the group containing the digest image data piece which is currently reproduced through the data reproducing section 15. Furthermore, the reproduction controlling section 16 identifies the main management information pieces in the identified group, that is, the desired main management information pieces.

The reproduction controlling section 16 controls the data reading/writing section 11 to suspend the reading of the digest image data pieces from the recording medium 10 and to sequentially read the identified main image data pieces (the desired main image data pieces) from the recording medium 10 by referring to the management information pieces in the internal memory. The data reading/writing section 11 sequentially passes the identified main image data pieces to the data reproducing section 15. The reproduction controlling section 16 controls the data reproducing section 15 to decode each identified main image data piece into a video signal. The data reproducing section 15 sequentially feeds the video signals to the monitor 18. In addition, the data reproducing section 15 sequentially feeds the video signals to the external display device through the video signal outputting section 19. The monitor 18 and the external display device sequentially visualize the video signals. In other words, the monitor 18 and the external display device successively indicate pictures represented by the original identified main image data piece. Thus, the contents of the identified main image data pieces, that is, the desired main image data pieces, are sequentially reproduced (played back). The sequential reproduction of the contents of the identified main image data pieces is in the order of shooting or recording date and time. For example, in the case where the command to replace the reproduction of the digest image data pieces with the reproduction of desired main image data pieces is inputted during the reproduction of the digest image data piece “d002” in the group “2”, the contents of the main image data piece “0021” and the later main image data pieces in the group “2” are sequentially reproduced (see FIG. 6). In the continuous absence of the replacing command, the contents of all the digest image data pieces are reproduced.

Preferably, the operation unit 17 has a button for allowing the user to input, into the image data reproducing apparatus, the command to replace the reproduction of the digest image data pieces with the reproduction of desired main image data pieces. Alternatively, a GUI-based button for this command may be indicated on the monitor 18. In this case, the user can input the command into the image data reproducing apparatus by pointing to the GUI-based button.

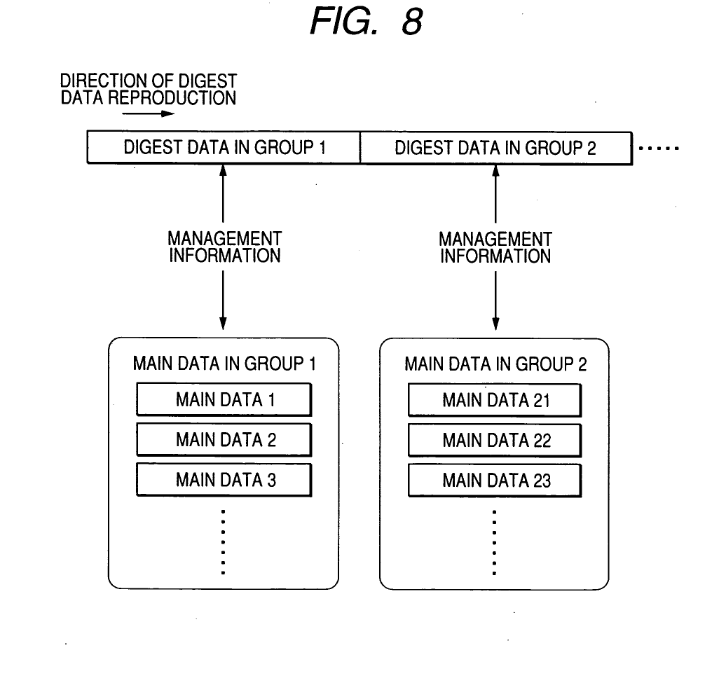

With reference to FIG. 8, the digest image data piece in the group “1”, the digest image data piece in the group “2”, the digest image data piece in the group “3”, . . . are sequentially reproduced by the image data reproducing apparatus in that order. Thus, the sequential reproduction of the digest image data pieces is along the direction from one in the oldest group toward one in the newest group. The management information pieces have components for allowing main image data pieces in each group to be identified. In the case where the command to replace the reproduction of the digest image data pieces with the reproduction of desired main image data pieces is inputted during the reproduction of the digest image data piece in the group “1”, the image data reproducing apparatus identifies the main image data pieces in the group “1” by referring to the management information pieces. Then, the image data reproducing apparatus sequentially reproduces the main image data piece “1”, the main image data piece “2”, . . . in the group “1”.

During the reproduction of the desired main image data pieces, the user can actuate the operation unit 17 to input, into the image data reproducing apparatus, a command to replace the reproduction of the desired main image data pieces with the reproduction of the digest image data pieces. In this case, the reproduction controlling section 16 receives the inputted command, and responds thereto. Specifically, the reproduction controlling section 16 refers to the management information pieces in the internal memory, and thereby identifies the group containing the desired main image data piece which is currently reproduced through the data reproducing section 15. Furthermore, the reproduction controlling section 16 identifies the digest management information piece in the identified group.

The reproduction controlling section 16 controls the data reading/writing section 11 to suspend the reading of the desired main image data pieces from the recording medium 10 and to sequentially read the identified digest image data piece and the digest image data pieces in the groups later than the group having the identified digest image data piece from the recording medium 10 by referring to the management information pieces in the internal memory. The data reading/writing section 11 sequentially passes the read digest image data pieces to the data reproducing section 15. The reproduction controlling section 16 controls the data reproducing section 15 to decode each read digest image data piece into a video signal. The data reproducing section 15 sequentially feeds the video signals to the monitor 18. In addition, the data reproducing section 15 sequentially feeds the video signals to the external display device through the video signal outputting section 19. The monitor 18 and the external display device sequentially visualize the video signals. In other words, the monitor 18 and the external display device successively indicate pictures represented by the original read digest image data pieces. Thus, the contents of the identified digest image data piece and the digest image data pieces in the groups later than the group having the identified digest image data piece are sequentially reproduced (played back). The sequential reproduction of the contents of the digest image data pieces is in the previously-mentioned group-based order.

Generally, the identified digest image data piece has a first part and a second part. The first part originates from a main image data piece or pieces preceding, in shooting or recording date and time, the main image data piece which is currently reproduced through the data reproducing device 15 at the time of the inputting of the command to replace the reproduction of the desired main image data pieces with the reproduction of the digest image data pieces. The original main image data pieces for the first part may include the main image data piece which is currently reproduced through the data reproducing device 15 at the time of the inputting of the command. The second part originates from the other main image data piece or pieces. Preferably, the whole of the identified digest image data piece is reproduced. Alternatively, only the second part of the identified digest image data may be reproduced.

Preferably, the operation unit 17 has a button for allowing the user to input, into the image data reproducing apparatus, the command to replace the reproduction of the desired main image data pieces with the reproduction of the digest image data pieces. Alternatively, a GUI-based button for this command may be indicated on the monitor 18. In this case, the user can input the command into the image data reproducing apparatus by pointing to the GUI-based button.

After the reproduction of the identified digest image data piece is completed, the digest image data pieces in the later groups may not be reproduced. In this case, the reproduction of the identified digest image data piece may be repeated.

As previously mentioned, main image data pieces in the recording medium 10 are classified into groups according to shooting or recording date and time. A digest image data piece is generated from a main image data piece or pieces in each of the groups before being recorded on the recording medium 10. When a user inputs, into the image data reproducing apparatus, a command to start the reproduction of the digest image data pieces, the image data reproducing apparatus sequentially reads the digest image data pieces from the recording medium 10 and reproduces pictures represented by the read digest image data pieces. Therefore, it is possible for the user to easily and quickly grasp the outlines of the contents of the main image data pieces on a group-by-group basis.

As previously mentioned, the main image group generating section 13 compares each of the intervals in shooting or recording date and time between the main image data pieces with the prescribed threshold value, and implements the grouping of the main image data pieces in accordance with the comparison results. Preferably, main image data pieces close to each other in shooting or recording date and time are placed in a same group. Main image data pieces having shooting or recording dates and times in a prescribed time range may be placed in a same group. In the case where the prescribed threshold value is equal to 24 hours (1 day), main image data pieces having a same shooting or recording date are placed in a same group. In this case, the grouping of the main image data pieces is on a day-by-day basis. The prescribed time range may be one eighth of a day. Information representing the prescribed time range is previously provided in the image data reproducing apparatus. The prescribed threshold value or the prescribed time range may be selected by the user on a GUI basis such that one can be chosen, by actuating the operation unit 17, from candidate values indicated on the monitor 18. The prescribed time range may be a resultant of equally dividing the interval between the oldest one and the newest one among the shooting or recording dates and times of the main image data pieces. Successive main image data pieces having play times, the total of which is equal to or less than a predetermined term, may be placed in a same group. In this case, the grouping of the main image data pieces is implemented according to shooting or recording date and time, and also play time. The grouping may be such that the resultant groups will be equal in number of main image data pieces belonging thereto.

In the case where the digest image data pieces are being sequentially reproduced, when the currently presented digest picture is desired one, the user actuates the operation unit 17 to input, into the image data reproducing apparatus, a command to replace the reproduction of the digest image data pieces with the reproduction of desired main image data pieces. In this case, the image data reproducing apparatus sequentially reproduces all the main image data pieces in the group having the digest image data piece representative of the desired digest picture. Therefore, by using the digest image data pieces, it is possible to easily search the main image data pieces for ones corresponding to a desired digest picture and being close to each other in shooting or recording date and time or being equal to each other in attribute. The search-result main image data pieces are played back (reproduced). Even in the case where the recording medium 10 stores many main image data pieces, it is easy to find and reproduce desired one among the main image data pieces. Furthermore, it is possible to reproduce main image data pieces close to the desired main image data piece in shooting or recording date and time.

The image data reproducing apparatus reads the main image data pieces from the recording medium 10 and visualizes the read main image data pieces. The user can search the main image data pieces for desired one while watching digests of pictures represented by the main image data pieces.

As previously mentioned, during the reproduction of the desired main image data pieces, the user can actuate the operation unit 17 to input, into the image data reproducing apparatus, a command to replace the reproduction of the desired main image data pieces with the reproduction of the digest image data pieces. In this case, the reproduction of the desired main image data pieces is suspended, and then the reproduction of the digest image data pieces is started or restarted. Therefore, after watching the contents of a main image data piece, the user can check digest pictures corresponding to another main image data piece spaced from the former main image data piece at longer than a given interval in shooting or recording date and time, or differing from the former main image data piece in attribute. Thus, in the event that a main image data piece different from desired one starts to be reproduced due to an erroneous action, the reproduction of the wrong main image data piece can be promptly replaced with the reproduction of the digest image data pieces for search.

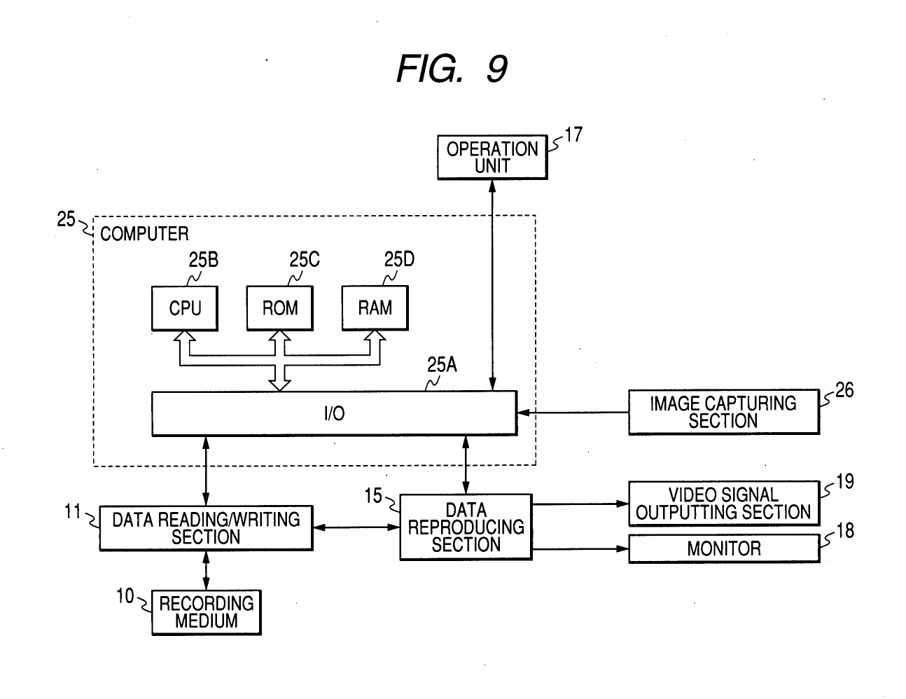

FIG. 9 shows the hardware structure of the image data reproducing apparatus. As shown in FIG. 9, the image data reproducing apparatus includes a computer 25. The main image data generating section 12, the main image group generating section 13, the digest image data generating section 14, and the reproduction controlling section 16 in FIG. 1 are implemented by the computer 25.

The computer 25 has an I/O port 25A, a CPU 25B, a ROM 25C, and a RAM 25D which are connected by a bus. The data reading/writing section 11, the data reproducing section 15, and the operation unit 17 are connected with the I/O port 25A of the computer 25. Various commands can be inputted into the I/O port 25A of the computer 25 by actuating the operation unit 17.

There is an image capturing section 26 connected with the I/O port 25A of the computer 25. During every shooting, the image capturing section 26 repetitively captures an image of a subject or a target scene, and generates a video data piece representing a stream of moving pictures or a set of still pictures formed by the respective captured images. The image capturing section 26 outputs each video data piece to the I/O port 25A of the computer 25.

The computer 25 or the CPU 25B operates in accordance with a control program (a computer program) stored in the ROM 25C or the RAM 25D. The control program is designed to enable the computer 25 or the CPU 25B to implement actions mentioned hereafter.

During a main data recording mode of operation of the image data reproducing apparatus, the computer 25 receives each video data piece from the image capturing section 26, and encodes the received video data piece to generate a main image data piece (a main image data sequence, a main image data block, or a main image data file). The computer 25 controls the data reading/writing section 11 to record the generated main image data piece on the recording medium 10.

For each main image data piece recorded on the recording medium 10, the computer 25 obtains or generates a management information piece representing the name and type of the recording medium 10, and the ID or name (file name), logical address (block address), recording date and time, shooting date and time, play time, and image quality of the main image data piece. To this end, the computer 25 includes a calendar and a clock. The computer 25 stores the management information piece in the RAM 25D. In addition, the computer 25 controls the data reading/writing section 11 to record the management information piece on the recording medium 10.

During a grouping mode of operation of the image data reproducing apparatus, the computer 25 accesses management information pieces in the RAM 25D or accesses management information pieces in the recording medium 10 through the data reading/writing section 11, and thereby detects the shooting or recording date and time of each of main image data pieces in the recording medium 10. The computer 25 classifies the main image data pieces into groups according to shooting or recording date and time. The computer 25 generates a management information piece representing which of the groups each of the main image data pieces belongs to. The computer 25 stores the generated management information piece in the RAM 25D. In addition, the computer 25 controls the data reading/writing section 11 to record the management information piece on the recording medium 10.

During a digest data generating mode of operation of the image data reproducing apparatus, the computer 25 accesses management information pieces in the RAM 25D or accesses management information pieces in the recording medium 10 through the data reading/writing section 11, and thereby detects the relation between groups and main image data pieces in the recording medium 10. For each group, the computer 25 accesses an in-group main image data piece or pieces in the recording medium 10 through the data reading/writing section 11 by referring to the management information pieces. For each group, the computer 25 produces a digest image data piece from the accessed main image data piece or pieces. The computer 25 controls the data reading/writing section 11 to record the digest image data pieces on the recording medium 10 on a group-by-group basis.

For each digest image data piece recorded on the recording medium 10, the computer 25 obtains or generates a management information piece representing the name and type of the recording medium 10, and the ID or name (file name), logical address (block address), recording date and time, play time, and image quality of the digest image data piece, and which of the groups the digest image data piece belongs to. The computer 25 stores the management information piece in the RAM 25D. In addition, the computer 25 controls the data reading/writing section 11 to record the management information piece on the recording medium 10.

During a main data reproducing mode of operation of the image data reproducing apparatus, a user informs the computer 25 of a desired main image data piece by actuating the operation unit 17. The computer 25 accesses management information pieces in the RAM 25D or accesses management information pieces in the recording medium 10 through the data reading/writing section 11. The computer 25 refers to the management information pieces and controls the data reading/writing section 11 to transfer the desired main image data piece from the recording medium 10 to the data reproducing section 15. The computer 25 controls the data reproducing section 15 to decode the desired main image data piece into a video signal. The data reproducing section 15 feeds the video signal to the monitor 18. The monitor 18 visualizes the video signal. In other words, the monitor 18 indicates the contents of the video signal. Thus, the contents of the desired main image data piece are played back (reproduced). In addition, the data reproducing section 15 feeds the video signal to the external display device through the video signal outputting section 19. The external display device visualizes the video signal. In other words, the external display device indicates the contents of the video signal. Thus, the contents of the desired main image data piece are played back (reproduced).

During a digest data reproducing mode of operation of the image data reproducing apparatus, the computer 25 accesses management information pieces in the RAM 25D or accesses management information pieces in the recording medium 10 through the data reading/writing section 11. The computer 25 refers to the management information pieces and controls the data reading/writing section 11 to sequentially transfer digest image data pieces from the recording medium 10 to the data reproducing section 15. The computer 25 controls the data reproducing section 15 to decode each digest image data piece into a video signal. The data reproducing section 15 sequentially feeds the video signals to the monitor 18. The monitor 18 sequentially visualizes the video signals. In other words, the monitor 18 sequentially indicates the contents of the video signals. Thus, the contents of the digest image data pieces are sequentially played back (reproduced). In addition, the data reproducing section 15 sequentially feeds the video signals to the external display device through the video signal outputting section 19. The external display device sequentially visualizes the video signals. In other words, the external display device sequentially indicates the contents of the video signals. Thus, the contents of the digest image data pieces are sequentially played back (reproduced).

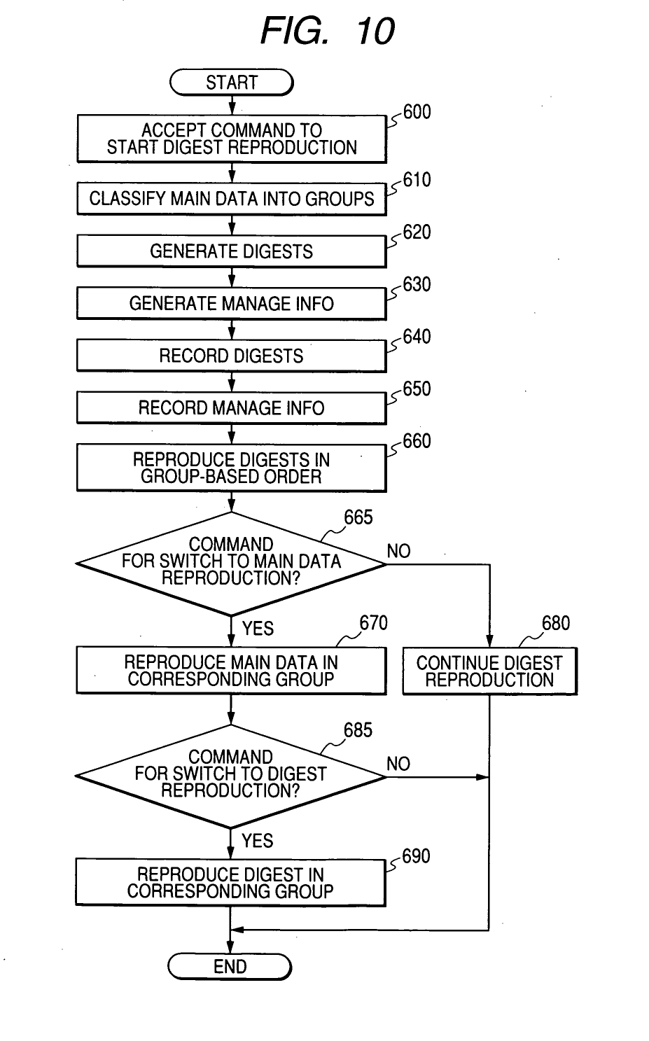

FIG. 10 is a flowchart of a segment of the control program for the computer 25 (the CPU 25B) which is started when a command to start the reproduction (playback) of digest image data pieces is inputted into the computer 25 from the operation unit 17.

As shown in FIG. 10, a first step 600 of the program segment accepts the inputted command to start the reproduction of the digest image data pieces.

A step 610 following the step 600 implements grouping main image data pieces in a recording medium 10. Specifically, the step 610 accesses management information pieces in the RAM 25D or accesses management information pieces in the recording medium 10 through the data reading/writing section 11 to detect the shooting or recording date and time of each of the main image data pieces and calculate the intervals in shooting or recording date and time between the main image data pieces. The step 610 classifies the main image data pieces into groups according to the calculated intervals in shooting or recording date and time therebetween. The step 610 generates a management information piece representing which of the groups each of the main image data pieces belongs to. The step 610 stores the generated management information piece in the RAM 25D.

A step 620 subsequent to the step 610 generates digest image data pieces for the respective groups. Specifically, the step 620 accesses the management information pieces in the RAM 25D, and thereby detects the relation between the groups and the main image data pieces in the recording medium 10. For each group, the step 620 accesses an in-group main image data piece or pieces in the recording medium 10 through the data reading/writing section 11 by referring to the management information pieces. For each group, the step 620 produces a digest image data piece from the accessed main image data piece or pieces.

A step 630 following the step 620 generates a management information piece for each digest image data piece. The generated management information piece represents the ID or name (file name), play time, and logical address (block address) of the related digest image data piece, and which of the groups the related digest image data piece belongs to. The step 630 stores the generated management information piece in the RAM 25D.

A step 640 subsequent to the step 630 controls the data reading/writing section 11 to record the digest image data pieces on the recording medium 10.

A step 650 following the step 640 reads, from the RAM 25D, the management information pieces generated by the step 610 and 630. The step 650 controls the data reading/writing section 11 to record the read management information pieces on the recording medium 10.

A step 660 subsequent to the step 650 controls the data reading/writing section 11 to sequentially transfer the digest image data pieces from the recording medium 10 to the data reproducing section 15 by referring to the management information pieces in the RAM 25D. The step 660 controls the data reproducing section 15 to decode each digest image data piece into a video signal, and to feed the video signal to the monitor 18. The step 660 may control the data reproducing section 15 to feed the video signal to the external display device through the video signal outputting section 19 also. Thus, the step 660 starts the sequential reproduction of the contents of the digest image data pieces.

A step 665 following the step 660 decides whether or not a command to replace the reproduction of the digest image data pieces with the reproduction of desired main image data pieces is inputted from the operation unit 17. When this command is inputted, the program advances from the step 665 to a step 670. Otherwise, the program advances from the step 665 to a step 680.

The step 670 refers to the management information pieces in the RAM 25D, and thereby identifies the group containing the digest image data piece which is currently reproduced through the data reproducing section 15. Furthermore, the step 670 identifies the main management information pieces in the identified group, that is, the desired main management information pieces. The step 670 controls the data reading/writing section 11 to suspend the transfer of the digest image data pieces from the recording medium 10 to the data reproducing section 15. Then, the step 670 controls the data reading/writing section 11 to sequentially transfer the identified main image data pieces from the recording medium 10 to the data reproducing section 15 by referring to the management information pieces in the RAM 25D. The step 670 controls the data reproducing section 15 to decode each identified main image data piece into a video signal, and to feed the video signal to the monitor 18. The step 670 may control the data reproducing section 15 to feed the video signal to the external display device through the video signal outputting section 19 also. Thus, the step 670 starts the sequential reproduction of the contents of the identified main image data pieces (the desired main image data pieces).

The step 680 continues the sequential reproduction of the contents of the digest image data pieces. After the step 680, the current execution cycle of the program segment ends.

A step 685 following the step 670 decides whether or not a command to replace the reproduction of the desired main image data pieces with the reproduction of the digest image data pieces is inputted from the operation unit 17 (for example, in a prescribed time from the moment of the start of the reproduction of the desired main image data pieces). When this command is inputted, the program advances from the step 685 to a step 690. Otherwise, the program exits from the step 685 and then the current execution cycle of the program segment ends.

The step 690 refers to the management information pieces in the RAM 25D, and thereby identifies the group containing the desired main image data piece which is currently reproduced through the data reproducing section 15. Furthermore, the step 690 identifies the digest management information piece in the identified group. The step 690 controls the data reading/writing section 11 to suspend the transfer of the desired main image data pieces from the recording medium 10 to the data reproducing section 15. Then, the step 690 controls the data reading/writing section 11 to sequentially transfer the identified digest image data piece and the digest image data pieces in the groups later than the group having the identified digest image data piece from the recording medium 10 to the data reproducing section 15 by referring to the management information pieces in the RAM 25D. The step 690 controls the data reproducing section 15 to decode each digest image data piece into a video signal, and to feed the video signal to the monitor 18. The step 690 may control the data reproducing section 15 to feed the video signal to the external display device through the video signal outputting section 19 also. Thus, the contents of the identified digest image data piece and the digest image data pieces in the groups later than the group having the identified digest image data piece are sequentially reproduced (played back). After the step 690, the current execution cycle of the program segment ends.

### Second Embodiment

A second embodiment of this invention is similar to the first embodiment thereof except that a digest data playlist is made in order to define or designate portions of main image data pieces as virtual digest image data pieces without generating actual digest image data pieces. Accordingly, it is unnecessary to record actual digest image data pieces on a recording medium 10. Thus, the capacity of the recording medium 10 can efficiently be used.

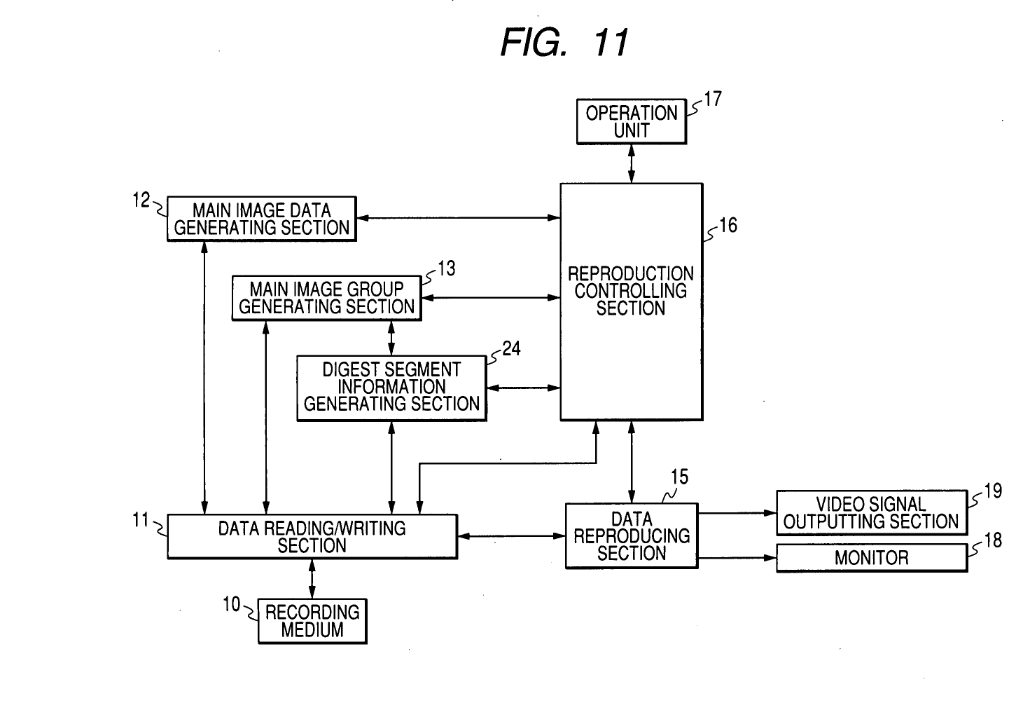

FIG. 11 shows an image data reproducing apparatus according to the second embodiment of this invention. The image data reproducing apparatus in FIG. 11 is similar to that in FIG. 1 except for design changes mentioned hereafter. The image data reproducing apparatus in FIG. 11 includes a digest segment information generating section 24 instead of the digest image data generating section 14 (see FIG. 1).

The digest segment information generating section 24 makes a digest data playlist for defining or designating portions of main image data pieces as virtual digest image data pieces without generating actual digest image data pieces. The digest data playlist contains digest segment information for denoting the start and the end of each of segments (portions) in the main image data pieces which are defined or handled as virtual digest image data pieces.

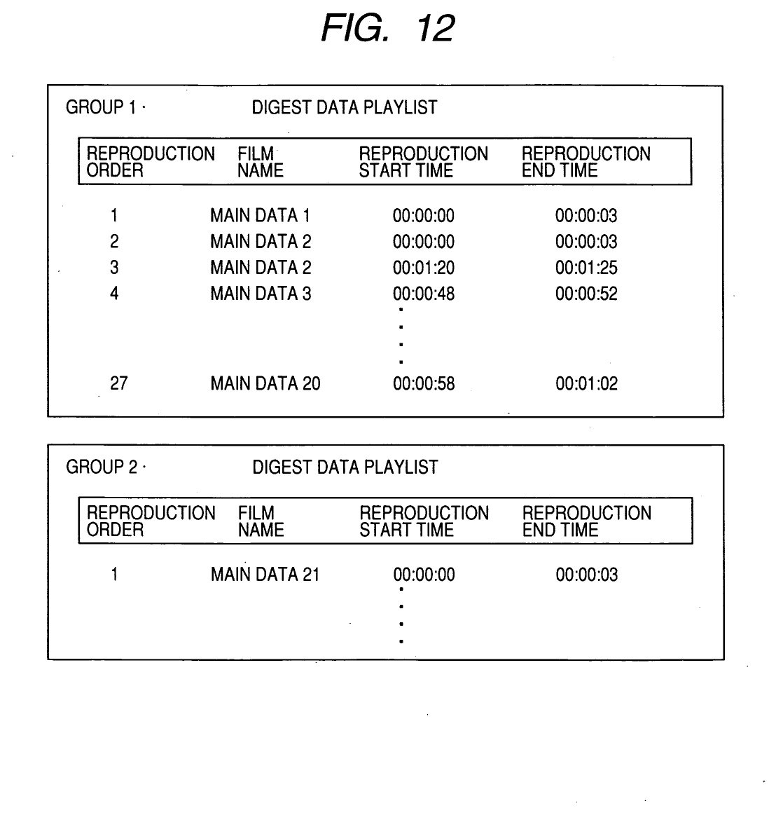

FIG. 12 shows an example of the digest data playlist made by the digest segment information generating section 24. With reference to FIG. 12, the digest data playlist is divided into blocks assigned to the respective groups. Each playlist division block indicates the start and the end of each of portions in main image data pieces in the related group, where the portions are defined or handled as a virtual digest image data piece for the group. In the playlist division block assigned to the group “1”, reproduction starting time and reproduction ending time (for example, “00:00:00” and “00:00:03” or “00:01:20” and “00:01:25”) are indicated as the start and the end of a digest-defining portion in each of main image data pieces in the group “1”. A succession of these portions of the main image data pieces in each group is defined or handled as a virtual digest image data piece for the group. Each playlist division block further indicates the playback order number for each of the digest-defining portions in the main image data pieces in the related group. In other words, each playlist division block further indicates the playback order along which the digest-defining portions in the main image data piece should be sequentially reproduced.

With reference to FIG. 12, the playback order number, the start time, and the end time of each of the digest-defining portions are described by digest segment information in the digest data playlist. The digest segment information generating section 24 produces the digest segment information, and stores the produced digest segment information in the internal memory within the reproduction controlling section 16. Thus, the digest segment information generating section 24 produces the digest data playlist, and stores the produced digest data playlist in the internal memory within the reproduction controlling section 16.

Preferably, the reproduction controlling section 16 or the digest segment information generating section 24 controls the data reading/writing section 11 to record the digest segment information (the digest data playlist) on the recording medium 10.

The reproduction controlling section 16 controls the data reading/writing section 11 to sequentially read the digest-defining portions of the main image data pieces from the recording medium 10 by referring to the digest segment information (the digest data playlist) in the internal memory. The digest segment information previously read from the recording medium 10 through the data reading/writing section 11 may be used for this purpose. The data reading/writing section 11 sequentially passes the digest-defining portions of the main image data pieces to the data reproducing section 15. The reproduction controlling section 16 controls the data reproducing section 15 to decode the sequence of the digest-defining portions of the main image data pieces into a video signal. The data reproducing section 15 feeds the video signal to the monitor 18. In addition, the data reproducing section 15 feeds the video signal to the external display device through the video signal outputting section 19. The monitor 18 and the external display device visualize the video signal. In other words, the monitor 18 and the external display device successively indicate pictures represented by the sequence of the digest-defining portions of the main image data pieces. Thus, the contents of the digest-defining portions of the main image data pieces are sequentially reproduced as the contents of virtual digest image data pieces.

The digest segment information may designate each digest-defining portion by indicating a first time elapsed from the head of a related main image data piece and a second time elapsed therefrom, where the first elapsed time corresponds to the start of the digest-defining portion while the second elapsed time corresponds to the end of the digest-defining portion. The digest segment information may include picture-position designating information accorded with an encoding system for the main image data pieces. A first example of the picture-position designating information is PTS information. A second example of the picture-position designating information indicates the number of GOPs from the head of a main image data piece as a designated picture position.

For each of the groups of the main image data pieces in the recording medium 10, the digest segment information generating section 24 designates portions of in-group main image data pieces as a virtual image data piece while making a corresponding block of the digest data playlist.

It is possible for the user to easily and quickly grasp the outlines of the contents of the main image data pieces on a group-by-group basis. Furthermore, it is possible to easily search the main image data pieces for desired ones being close to each other in shooting or recording date and time or being equal to each other in attribute.

The digest segment information in the digest data playlist indicates the starting points and the ending points of portions of the main image data pieces which are defined or handled as virtual digest image data pieces. It is unnecessary to generate actual digest image data pieces which should be recorded on the recording medium 10. Accordingly, the capacity of the recording medium 10 can efficiently be used.

### Third Embodiment

A third embodiment of this invention is similar to the first or second embodiment thereof except that main image data pieces in a recording medium 10 are classified into groups according to day through the use of the shooting or recording date and time of each of the main image data pieces.

It is assumed that the recording medium 10 stores 20 main image data pieces each having a shooting or recording date of April 29 in this year, 30 main image data pieces each having a shooting or recording date of May 3 in this year, 40 main image data pieces each having a shooting or recording date of May 4 in this year, and 10 main image data pieces each having a shooting or recording date of May 5 in this year.

The main image group generating section 13 accesses management information pieces in the reproduction controlling section 16 or accesses management information pieces in the recording medium 10 through the data reading/writing section 11, and thereby detects the shooting or recording date and time of each of the main image data pieces in the recording medium 10. The main image group generating section 13 classifies the main image data pieces into groups according to day through the use of the shooting or recording date and time of each of the main image data pieces. Specifically, the 20 main image data pieces each having a shooting or recording date of April 29 in this year are placed in a group “1”. The 30 main image data pieces each having a shooting or recording date of May 3 in this year are placed in a group “2”. The 40 main image data pieces each having a shooting or recording date of May 4 in this year are placed in a group “3”. The 10 main image data pieces each having a shooting or recording date of May 5 in this year are placed in a group “4”.

The digest image data generating section 14 or the digest segment information generating section 24 operates as follows.

The digest image data generating section 14 generates a digest image data piece from the main image data pieces in the group “1” (that is, the 20 main image data pieces each having a shooting or recording date of April 29 in this year). The digest image data generating section 14 generates a digest image data piece from the main image data pieces in the group “2” (that is, the 30 main image data pieces each having a shooting or recording date of May 3 in this year). The digest image data generating section 14 generates a digest image data piece from the main image data pieces in the group “3” (that is, the 40 main image data pieces each having a shooting or recording date of May 4 in this year). The digest image data generating section 14 generates a digest image data piece from the main image data pieces in the group “4” (that is, the 10 main image data pieces each having a shooting or recording date of May 5 in this year).

The digest segment information generating section 24 makes a playlist division block designating portions of the main image data pieces in the group “1” as a virtual image data piece for the group “1”, a playlist division block designating portions of the main image data pieces in the group “2” as a virtual image data piece for the group “2”, a playlist division block designating portions of the main image data pieces in the group “3” as a virtual image data piece for the group “3”, and a playlist division block designating portions of the main image data pieces in the group “4” as a virtual image data piece for the group “4”.

It is possible for the user to easily and quickly grasp the outlines of the contents of the main image data pieces on a group-by-group basis. Furthermore, it is possible to easily search the main image data pieces for desired ones being close to each other in shooting or recording date and time or being equal to each other in attribute. Since the main image data pieces in the recording medium 10 are classified according to day, it is possible to make actual or visual digest image data pieces on a day-by-day basis.

### Fourth Embodiment

A fourth embodiment of this invention is similar to one of the first, second, and third embodiments thereof except for design changes mentioned hereafter.

In the fourth embodiment of this invention, the digest image data pieces generated by the digest image data generating section 14 are recorded in a memory different from the recording medium 10. An example of such a memory is an internal memory within the digest image data generating section 14 or the internal memory within the reproduction controlling section 16.

The digest segment information (the digest data playlist) made by the digest segment information generating section 24 is recorded in a memory different from the recording medium 10. An example of such a memory is an internal memory within the digest segment information generating section 24.

### Fifth Embodiment

A fifth embodiment of this invention is similar to one of the first, second, and third embodiments thereof except for design changes mentioned hereafter.

The fifth embodiment of this invention is designed for a recording medium 10 which stores main image data pieces and digest image data pieces in advance. The fifth embodiment of this invention includes a data reading section instead of the data reading/writing section 11.

### Sixth Embodiment

A sixth embodiment of this invention is similar to the first or third embodiment thereof except for design changes mentioned hereafter.

In the sixth embodiment of this invention, the control program for the computer 25 (the CPU 25B) includes first and second segments. The first program segment is started when a command to start the generation of digest image data pieces is inputted into the computer 25 from the operation unit 17. The second program segment is started when a command to start the reproduction (playback) of digest image data pieces is inputted into the computer 25 from the operation unit 17.

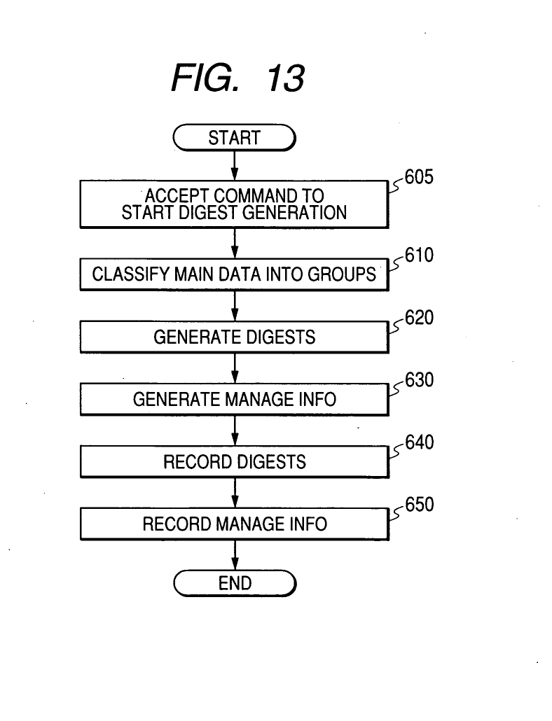

FIG. 13 is a flowchart of the first program segment. As shown in FIG. 13, a first step 605 of the first program segment accepts the inputted command to start the generation of the digest image data pieces. The step 605 is followed by a sequence of steps 610, 620, 630, 640, and 650 similar to those in FIG. 10. After the step 650, the current execution cycle of the first program segment ends.

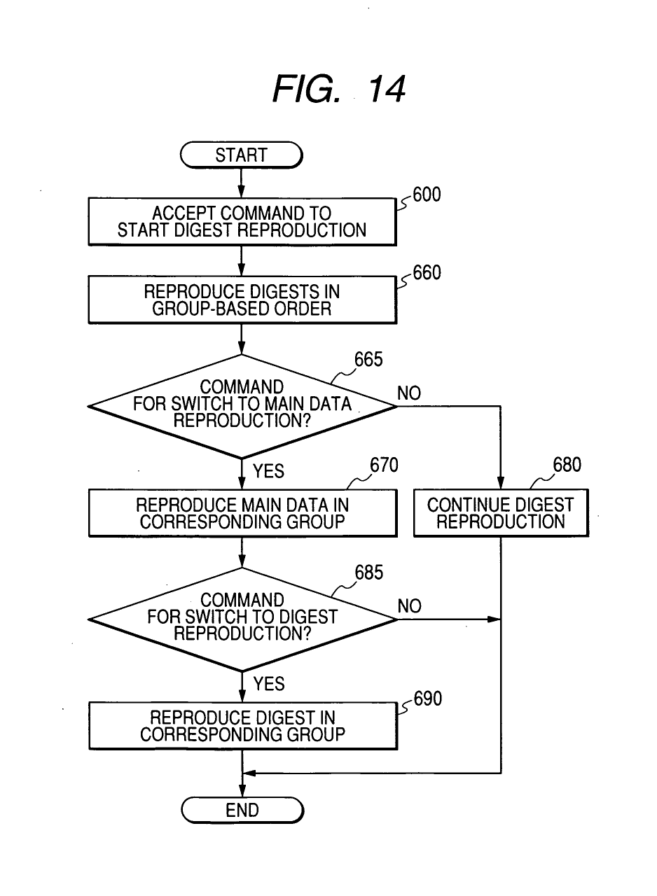

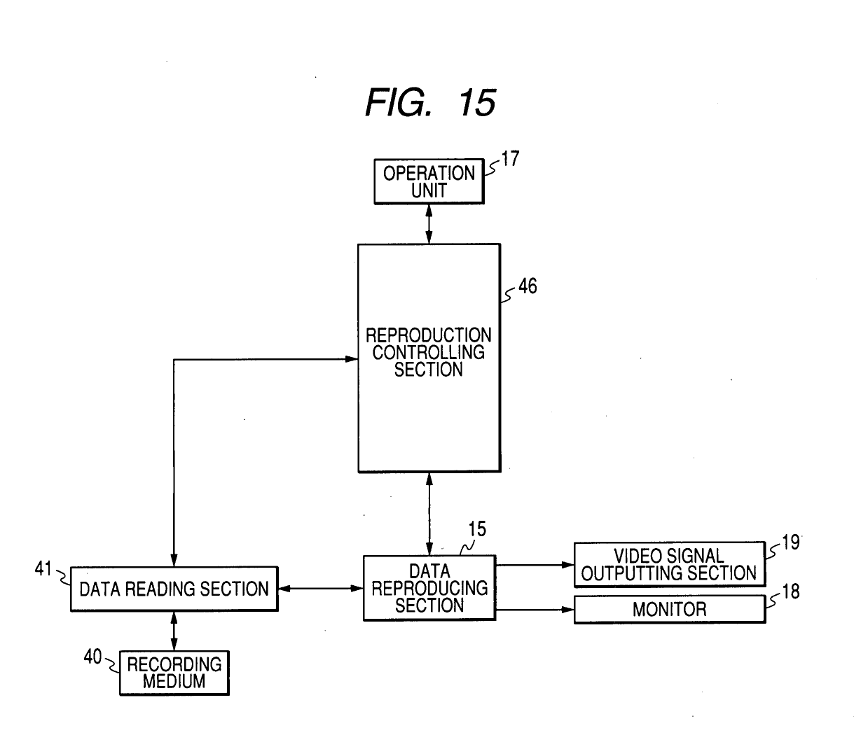

FIG. 14 is a flowchart of the second program segment. As shown in FIG. 14, a first step 600 of the program segment accepts the inputted command to start the reproduction of the digest image data pieces. The step 600 is followed by a set of steps 660, 665, 670, 680, 685 and 690 similar to those in FIG. 10.

Preferably, the image data reproducing apparatus includes a rechargeable battery as a power supply, and a sensor for detecting the start of charging the battery. In this case, the detected start of charging the battery may be used as the command to start the generation of digest image data pieces.

Preferably, the image data reproducing apparatus has a first section for detecting the total amount of data constituting main image data pieces recorded on the recording medium 10, and a second section for deciding whether or not the detected total data amount reaches a prescribed value. In this case, the detected total data amount reaching the prescribed value may be used as the command to start the generation of digest image data pieces.

### Seventh Embodiment

FIG. 15 shows an image data reproducing apparatus according to a seventh embodiment of this invention. Preferably, the image data reproducing apparatus in FIG. 15 forms a medium player for playing back the recorded contents of a recording medium 40. An example of the medium player is a DVD player, a BD player, an HDD player, or a memory player.

The recording medium 40 stores first image data pieces and second image data pieces in advance. According to a first example, the first image data pieces are main image data pieces while the second image data pieces are digest image data pieces formed by portions of the main image data pieces. In this case, the stored main image data pieces may be classified into groups, and the digest image data pieces may correspond to the respective groups. According to a second example, the first image data pieces are main image data pieces while the second image data pieces represent commercial videos.

The image data reproducing apparatus of FIG. 15 includes the data reproducing section 15, the operation unit 17, the monitor 18, and the video signal outputting section 19 similar to those in FIG. 1. The image data reproducing apparatus in FIG. 15 further includes a data reading section 41 and a reproduction controlling section 46.

Preferably, the data reading section 41 is associated with the recording medium 40. The data reading section 11 is connected with the data reproducing section 15 and the reproduction controlling section 46. The reproduction controlling section 46 is connected with the operation unit 17 and the data reproducing section 15.

Preferably, the data reading section 41 includes a drive for the recording medium 40. The data reading section 41 operates to read data from the recording medium 40. Preferably, the recording medium 40 is removable from the body of the image data reproducing apparatus. An example of the recording medium 40 is a DVD, a BD, a hard disc, or a memory.

The reproduction controlling section 46 controls the data reading section 41 and the data reproducing section 15 to implement the start, stop, pause, fast feed, and fast rewind of the playback or reproduction of each main image data piece or each digest image data piece. The reproduction controlling section 16 responds to a command signal inputted via the operation unit 17. Specifically, the command signal is designed so that a switch between the reproduction of main image data pieces and the reproduction of digest image data pieces can be provided in accordance with user's request, and that the reproduction of each main or digest image data piece can be controlled in accordance with user's request.

The image data reproducing apparatus in FIG. 15 is similar to the image data reproducing apparatus in FIG. 1 except that the data reading section 41 and the reproduction controlling section 46 replace the data reading/writing section 11 and the reproduction controlling section 16 (see FIG. 1) respectively, and that the main image data generating section 12, the main image group generating section 13, and the digest image data generating section 14 (see FIG. 1) are omitted.

The grouping of the main image data pieces in the recording medium 40 is similar to that in the first embodiment. The structure of the digest image data pieces in the recording medium 40 is similar to that in the first embodiment.

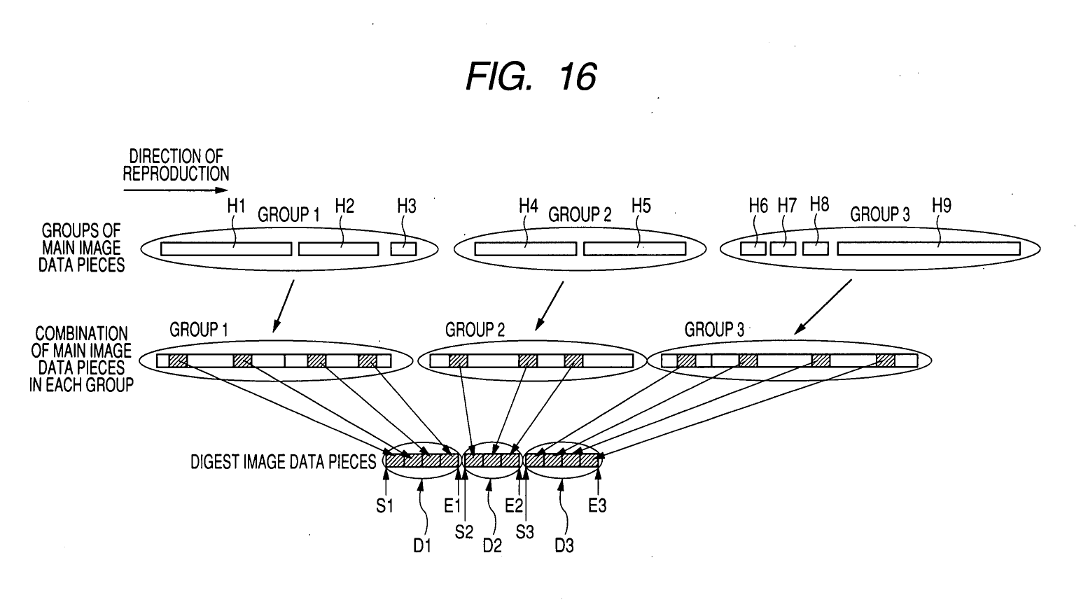

FIG. 16 shows time-domain conditions of main image data pieces H1-H9 in the recording medium 40, groups “1”, “2”, and “3” of the main image data pieces H1-H9, and digest image data pieces D1-D3 in the recording medium 40 which are similar to those in FIG. 2.

The recording medium 40 may store a playlist instead of the digest image data pieces D1-D3. The playlist indicates that the main image data pieces H1, H2, and H3 are in the group “1” and the main image data pieces H4 and H5 are in the group “2”, and the main image data pieces H6, H7, H8, and H9 are in the group “3”. The playlist further indicates the names of the groups “1”, “2”, and “3”, and the names of the main image data pieces H1-H9. The playlist contains digest segment information for indicating the start and the end of each of segments (portions) in the main image data pieces H1-H9 which are defined or handled as virtual digest image data pieces. Preferably, the digest segment information is positional information representing the logical addresses of the start and the end of each of the digest-defining portions in the main image data pieces H1-H9.

In the case where the recording medium 40 stores the playlist, the reproduction of the digest-defining portions in the main image data pieces H1-H9 causes the reproduction of the virtual digest image data pieces. It should be noted that the main image data pieces H1-H9 may be grouped according to day about shooting or recording date.

In FIG. 16, time stamps S1 and E1 correspond to the start and the end of the digest image data piece D1, respectively. Time stamps S2 and E2 correspond to the start and the end of the digest image data piece D2, respectively. Time stamps S3 and E3 correspond to the start and the end of the digest image data piece D3, respectively. The time stamps S1, E1, S2, E2, S3, and E3 are used for synchronization in the decoding of the digest image data pieces D1, D2, and D3.

Data pieces recorded on the recording medium 40 take one of the following four patterns (1), (2), (3), and (4):
(1) First image data pieces and second image data pieces are recorded, where the first image data pieces are before-grouping main image data pieces while the second image data pieces are digest image data pieces.
(2) First image data pieces and second image data pieces are recorded, where the first image data pieces are after-grouping main image data pieces while the second image data pieces are digest image data pieces.
(3) First image data pieces and second image data pieces are recorded, where the first image data pieces are before-grouping main image data pieces and after-grouping main image data pieces while the second image data pieces are digest image data pieces.
(4) Before-grouping main image data pieces, first image data pieces, and second image data pieces are recorded, where the first image data pieces are after-grouping main image data pieces while the second image data pieces are digest image data pieces.

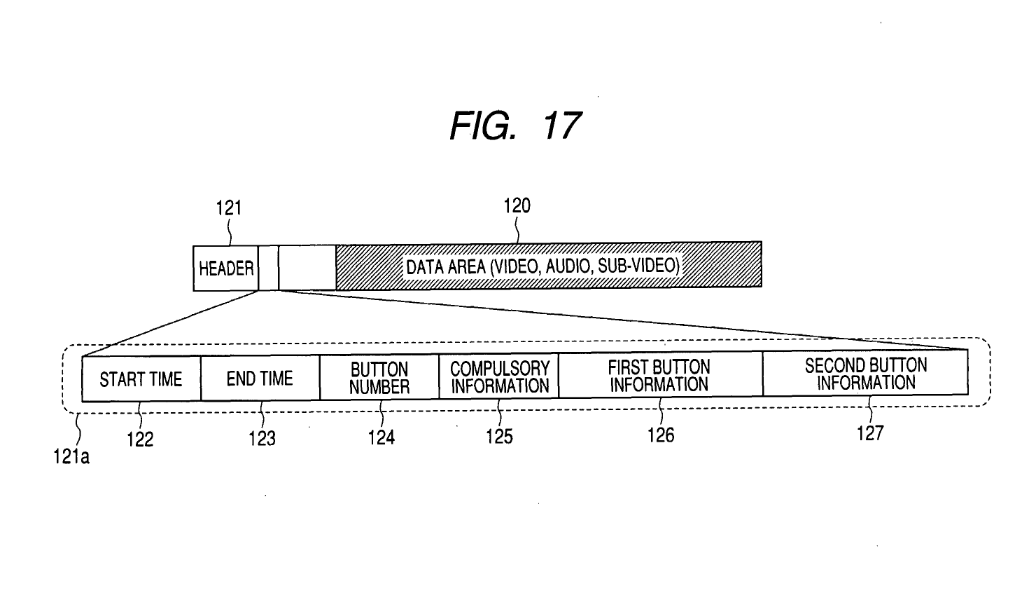

FIG. 17 shows the structure of one digest image data piece being a second image data piece in each of the above-mentioned patterns (1), (2), (3), and (4). As shown in FIG. 17, one digest image data piece consists of a data area 120 and a header 121 preceding the data area 120. The data area 120 holds actual video and audio data resulting from re-encoding the connection of digest-defining portions of main image data pieces in one group. The data area 120 further holds added actual sub-video data. The header 121 stores link information 121a.

The link information 121a is divided into first to sixth segments which are sequentially arranged. The first link information segment has time information representing the starting time 122. The second link information segment has time information representing the ending time 123. The starting time 122 and the ending time 123 define a term during which the link information 121a is effective. The third link information segment indicates the number 124 of button information pieces in the link information 121a. The fourth link information segment has compulsory information (mandatory information) 125. The fifth link information segment has a first button information piece 126 for instructing the reproduction of main image data pieces in a predesignated group. The sixth link information segment has a second button information piece 127 for instructing the reproduction of a digest image data piece in another predesignated group.

For example, the starting time 122 and the ending time 123 are those denoted by the time stamps S1 and E1, respectively. In this case, during the reproduction of the digest image data piece for the group “1”, the image data reproducing apparatus regards the button information pieces 126 and 127 in the link information 121a as being effective.

Preferably, the starting time 122 and the ending time 123 describe the respective times elapsed from the moment of the start of the reproduction of the actual video, audio, and sub-video data in the related data area 120. In this case, the starting time 122 and the ending time 123 define the term during which the button information pieces 126 and 127 are effective. The starting time 122 being “0” denotes that the link information 121a is effective from the moment of the start of the related digest image data piece. Units of the starting time 122 and the ending time 123 are hours, minutes, seconds, the number of frames from the head, the number of GOPs from the head, or PTSs. The ending time 123 equal to the moment of the end of the last one among the main image data pieces in the related group denotes that the link information 121a is effective throughout the term of the reproduction of the actual video, audio, and sub-video data.

The button number 124 indicates the number of button information pieces following the compulsory information 125. In FIG. 17, there are two button information pieces, and the button number 124 is “2”. In the case where the button number 124 is fixed, the related link information segment (the third link information segment) may be omitted. Only one of the button information pieces 126 and 127 may be in the link information 121a. Three or more button information pieces may be in the link information 121a.

The compulsory information 125 represents the ID number of one virtually selected from the button information pieces 126 and 127. Thus, the compulsory information 125 denotes the virtual selection of the first button information piece 126 or the second button information piece 127. The compulsory information 125 is regarded as being valid in the absence of user's selection of an arbitrary button information piece or user's request for the stop of the reproduction of a digest image data piece from the term between the starting time 122 and the ending time 123 during which the link information 121a is effective.

Each of the button information pieces 126 and 127 represents conditions of a related button to be indicated on the monitor 18 such as the color, shape, and on-screen position of the button. Each of the button information pieces 126 and 127 further represents the ID number of a group of main image data pieces, the ID number of a main image data piece being a link destination for the present digest image data piece, the ID number of a main image data piece which should start to be reproduced when the button information piece is selected, or the ID number of a digest image data piece in a group next to the group having the present digest image data piece.

For example, the first button information piece 126 represents the ID number of one of main image data pieces in the group having the present digest image data piece or the ID number of the group of the main image data pieces corresponding to the present digest data piece. The second button information piece 127 represents the ID number of a digest image data piece in the group next to that described in the first button information piece 126 or the ID number of the group next to that described in the first button information piece 126. In the link information 121a for the digest image data piece D1, the first button information piece 126 represents the ID number of one of the main image data pieces H1, H2, and H3 in the group “1” having the digest image data piece D1 or the ID number of the group “1”. The second button information 127 represents the ID number of the digest image data piece D2 in the group “2” next to that described in the first button information piece 126 or the ID number of the group “2”.

The image data reproducing apparatus operates as follows. A user actuates the operation unit 17 to input, into the image data reproducing apparatus, a command to start the reproduction (playback) of a digest image data piece. The reproduction controlling section 46 receives the inputted command, and responds thereto. Specifically, the reproduction controlling section 46 controls the data reading section 41 to read the first digest image data piece (the digest image data piece D1) from the recording medium 40 according to the digest reproduction order.

The operation unit 17 may have buttons which allow the user to directly input the numeral corresponding to the ID number of a desired group. The operation unit 17 may be provided with a remote control unit having buttons which allow the user to directly input the numeral corresponding to the ID number of a desired group. The image data reproducing apparatus may be provided with a GUI (Graphical User Interface) associated with the operation unit 17 and the monitor 18. According to the GUI, the operation unit 17 has cross keys and arrow buttons for up, down, left, and right movements, and a decision button. The monitor 18 is controlled to indicate a list of groups of main image data pieces in the recording medium 40. The groups in the indicated list are associated with the keys and the buttons on the operation unit 17. The user can select one from the listed groups as desired one by actuating the operation unit 17. In these cases, when a desired group is notified, the reproduction controlling section 46 controls the data reading section 41 to sequentially read a digest image data piece in the desired group and later digest image data pieces from the recording medium 40.

The reproduction controlling section 46 may store information about a resume point into an internal memory therein. The resume point information indicates the position at which the previous digest reproduction is suspended. The position indicated by the resume point information is expressed by the ID number of the concerned group or by the number of frames, the number of GOPs, or the number of seconds corresponding to a point (a resume point) in the concerned digest image data piece. The reproducing controlling section 46 may control the data reading section 41 and the data reproducing section 15 to restart the digest reproduction from the resume point by referring to the stored resume point information.

The data reading section 41 sends the header 121 of the digest image data piece D1 to the reproduction controlling section 46 and sends the data area 120 thereof to the data reproducing section 15 under the control by the reproduction controlling section 46.

The reproduction controlling section 46 controls the data reproducing section 15 in response to the header 121 of the digest image data piece D1 so that the reproduction of the contents of the data area 120 of the digest image data piece D1 through the data reproducing section 15 will be governed according to the header 121 of the digest image data piece D1. Under the control by the reproduction controlling section 46, the data reproducing section 15 decodes the actual video, audio, and sub-video data in the data area 120 of the digest image data piece D1 into a video signal and an audio signal. The reproducing controlling section 46 generates or derives display information from the header 121 of the digest image data piece D1. The reproducing controlling section 46 controls the data reproducing section 15 to add the display information to the video signal. Accordingly, every picture represented by the video signal can have not only portions originating from the actual video data and the actual sub-video data but also portions relating to or originating from the header 121 of the digest image data piece D1. The data reproducing section 15 feeds the video signal to the monitor 18, and feeds the audio signal to loudspeakers (not shown). In addition, the data reproducing section 15 feeds the video signal and the audio signal to the external display device through the video signal outputting section 19. Preferably, the external display device contains loudspeakers. The monitor 18 and the external display device visualize the video signal while the loudspeakers convert the audio signal into sounds. In other words, the monitor 18 and the external display device successively indicate pictures represented by the original digest image data piece D1 while the loudspeakers generate sounds represented by the original digest image data piece D1. Thus, the contents of the digest image data piece D1 are reproduced (played back).

The pictures represented by the digest image data pieces D1 constitute a digest of the pictures represented by the main image data pieces H1, H2, and H3. The digest pictures are presented to the user through the monitor 18 and the external display device. By watching the presented digest pictures, the user can easily grasp the contents of the main image data pieces H1, H2, and H3. The above-mentioned operation steps can also be applied to the digest image data pieces D2 and D3. Thus, the user can search the main image data pieces H1-H9 for ones desired by the user or ones having shooting or recording dates and times in a specified term.

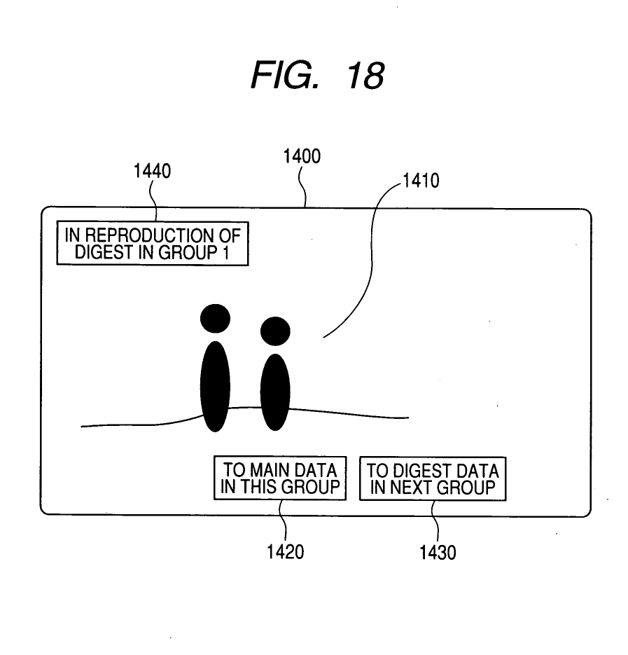

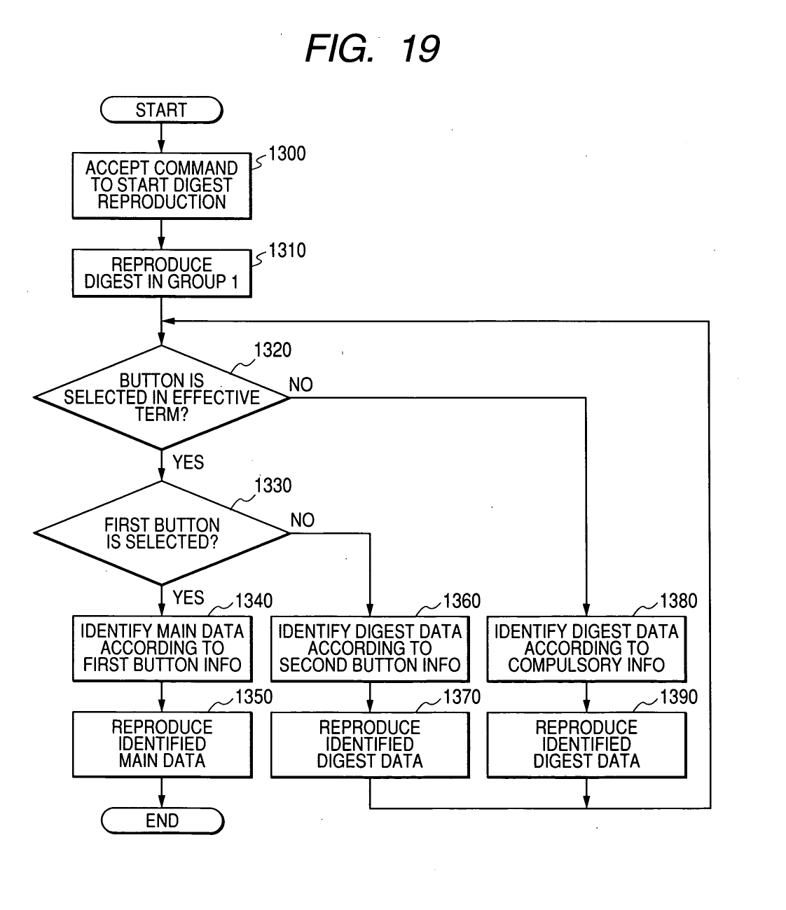

FIG. 18 shows an exemplary digest picture 1400 indicated by the monitor 18 and the external display device. The digest picture 1400 has a central portion 1410 originating from the actual video data, a first button 1420 located in a lower part of the digest picture 1400 and originating from the first button information piece 126, a second button 1430 located in the lower part of the digest picture 1400 and originating from the second button information piece 127, and a window 1440 located in an upper part of the digest picture 1400 and originating from the actual sub-video data. The first button 1420 has a message “to main data in this group”. The second button 1430 has a message “to digest data in the next group”. The window 1440 has a message “in digest reproduction for group “1””.

The color, shape, and on-screen position of the first button 1420 are decided by the first button information 126. The color, shape, and on-screen position of the second button 1430 are decided by the second button information piece 127. Each of the first button 1420 and the second button 1430 may be designed to change in color or shape when being selected. According to the GUI, the user can select the first button 1420 or the second button 1430, and decide or cancel the selection by actuating the operation unit 17. When the first button 1420 is selected and then the selection is decided, the reproduction of the digest image data piece D1 is replaced by the reproduction of the main image data pieces H1, H2, and H3 in the group “1” having the digest image data piece D1. When the second button 1420 is selected and then the selection is decided, the reproduction of the digest image data piece D1 is replaced by the reproduction of the digest image data piece D2 in the group “2” next to the group “1” having the digest image data piece D1.

By referring to the signals from the operation unit 17, the reproduction controlling section 46 decides whether or not the first button 1420 is selected and then the selection is decided after the starting time 122 indicated by the link information 121a and before the ending time 123 indicated by the link information 121a. In other words, the reproduction controlling section 46 decides whether or not the first button 1420 is selected and then the selection is decided during the effective term for the link information 121a. Preferably, this decision utilizes a clock signal generated within the reproduction controlling section 46 or a clock signal used by the data reproducing section 15 for the decoding.

In the case where the first button 1420 is selected and then the selection is decided during the effective term for the link information 121a, the reproduction controlling section 46 controls the data reading section 41 and the data reproducing section 15 to replace the reproduction of the digest image data piece D1 with the reproduction of the main image data pieces H1, H2, and H3 in the group “1” having the digest image data piece D1.

The reproduction controlling section 46 may store information about a resume point into an internal memory therein. The resume point information indicates the position at which the previous reproduction of a main image data piece is suspended. The position indicated by the resume point information is expressed by the number of bytes, the number of GOPs, the number of frames, or the time elapsed from the head of the main image data piece. This position corresponds to a point (a resume point) in the main image data piece. The reproducing controlling section 46 may control the data reading section 41 and the data reproducing section 15 to restart the reproduction of the main image data piece from the resume point by referring to the stored resume point information.

Replacing the digest reproduction with the main data reproduction is implemented as follows. The reproduction controlling section 46 controls the data reading section 41 and the data reproducing section 15 to suspend the reproduction of the digest image data piece D1. By referring to the first button information piece 126, the reproducing controlling section 46 identifies the main image data pieces H1, H2, and H3 in the group “1” having the digest image data piece D1. The reproducing controlling section 46 controls the data reading section 41 and the data reproducing section 15 to sequentially reproduce the main image data pieces H1, H2, and H3 from the recording medium 40 as in the first or third embodiment of this invention.

In the case where the first button information piece 126 represents the ID number of the first one among the main image data pieces H1, H2, and H3 in the group “1” having the digest image data piece “1” rather than the ID number of the group “1”, the main image data pieces H1, H2, and H3 are sequentially reproduced also.

Thus, it is possible for the user to easily follow the link from the digest image data piece D1 to the group “1” of the main image data pieces H1, H2, and H3, and to sequentially watch the contents of the main image data pieces H1, H2, and H3. Similar to the operation of the second embodiment of this invention, the digest image data piece D1 may be replaced by digest segment information designating portions (digest-defining portions) of the main image data pieces H1, H2, and H3 as a virtual digest image data piece. In this case, the reproduction of the digest-defining portions of the main image data pieces H1, H2, and H3 is implemented instead of the reproduction of the digest image data piece D1. Furthermore, when the first button 1420 is selected and then the selection is decided, the reproduction of the digest-defining portions of the main image data pieces H1, H2, and H3 is suspended. At the same time, the main image data pieces H1, H2, and H3 in the group “1” are identified according to the digest segment information. Then, the main image data pieces H1, H2, and H3 are sequentially reproduced.

By referring to the signals from the operation unit 17, the reproduction controlling section 46 decides whether or not the second button 1430 is selected and then the selection is decided after the starting time 122 indicated by the link information 121a and before the ending time 123 indicated by the link information 121a. In other words, the reproduction controlling section 46 decides whether or not the second button 1430 is selected and then the selection is decided during the effective term for the link information 121a.

In the case where the second button 1430 is selected and then the selection is decided during the effective term for the link information 121a, the reproduction controlling section 46 controls the data reading section 41 and the data reproducing section 15 to replace the reproduction of the digest image data piece D1 with the reproduction of the digest image data piece D2 in the group “2” next to the group “1” having the digest image data piece D1.

Replacing the reproduction of the digest image data piece D1 with that of the digest image data piece D2 is implemented as follows. The reproduction controlling section 46 controls the data reading section 41 and the data reproducing section 15 to suspend the reproduction of the digest image data piece D1. By referring to the second button information piece 127, the reproducing controlling section 46 identifies the digest image data piece D2 in the group “2” next to the group “1” having the digest image data piece D1. The reproducing controlling section 46 controls the data reading section 41 and the data reproducing section 15 to reproduce the digest image data piece D2.

In the case where the second button information piece 127 represents the ID number of the digest image data piece D2 in the group “2” rather than the ID number of the group “2”, the digest image data piece D2 is reproduced also.

In the event that neither the first button 1420 nor the second button 1430 is selected during the effective term for the link information 121a, the reproduction controlling section 46 refers to the compulsory information 125 and responds thereto. When the compulsory information 125 denotes the virtual selection of the second button information piece 127 (that is, the virtual selection of the second button 1430), the reproduction controlling section 46 controls the data reading section 41 and the data reproducing section 15 to replace the reproduction of the digest image data piece D1 with the reproduction of the digest image data piece D2 in the group “2” next to the group “1” having the digest image data piece D1. Replacing the reproduction of the digest image data piece D1 with that of the digest image data piece D2 is implemented as follows. The reproduction controlling section 46 controls the data reading section 41 and the data reproducing section 15 to suspend the reproduction of the digest image data piece D1. By referring to the second button information piece 127, the reproducing controlling section 46 identifies the digest image data piece D2 in the group “2” next to the group “1” having the digest image data piece D1. The reproducing controlling section 46 controls the data reading section 41 and the data reproducing section 15 to reproduce the digest image data piece D2. In this way, the reproduction of the digest image data piece D1 in the group “1” is automatically replaced with the reproduction of the digest image data piece D2 in the next group “2”.

The first button information piece 126 may describe the ID number of a group different from the group “1” having the digest image data piece D1 or the ID number of a main image data piece in the group different from the group “1”. In this case, the reproduction of the digest image data piece D1 can be replaced with the reproduction of the main image data piece in the group different from the group “1”.

The second button information piece 127 may describe the ID number of a group different from the group “2” next to the group “1” having the digest image data piece D1 or the ID number of a digest image data piece in the group different from the group “2”. In this case, the reproduction of the digest image data piece D1 can be replaced with the reproduction of the digest image data piece in the group different from the group “2”.

With reference back to FIGS. 16 and 17, the main image data pieces H1-H9 are classified into the groups “1”, “2”, and “3”. The main image data pieces in each of the groups “1”, “2”, and “3” are connected and combined into one image data stream. The digest image data piece D1 represents a digest of pictures represented by the image data stream in the group “1”. The digest image data piece D2 represents a digest of pictures represented by the image data stream in the group “2”. The digest image data piece D3 represents a digest of pictures represented by the image data stream in the group “3”. The link information 121a in the headers 121 of the digest image data pieces D1-D3 provides links between the main image data pieces H1-H9 (or the data streams) and the digest image data pieces D1-D3. The provided links are in a group-corresponding unit. The links allow an easy switch from the reproduction of a digest image data piece to the reproduction of a main image data piece in a desired group.

As previously mentioned, each digest image data piece in the recording medium 40 includes the first button information piece 126 and the second button information piece 127. The first button information piece 126 is designed to instruct the replacement of the reproduction of the present digest image data piece with the reproduction of a main image data piece in the group having the present digest image data piece. The second button information piece 127 is designed to instruct the replacement of the reproduction of the present digest image data piece with the reproduction of a digest image data piece in the group next to the group having the present digest image data piece. The digest picture 1400 on the monitor 18 has the first button 1420 corresponding to the first button information piece 126, and the second button 1430 corresponding to the second button information piece 127. The first button 1420 and the second button 1430 are presented to the user. By actuating the operation unit 17, the user can select one from the first and second buttons 1420 and 1430. When the first button 1420 is selected, the first button information piece 126 is selected and is referred to. In this case, according to the first button information piece 126, the reproduction of the present digest image data piece is replaced with the reproduction of a main image data piece in the group having the present digest image data piece. On the other hand, when the second button 1430 is selected, the second button information piece 127 is selected and is referred to. In this case, according to the second button information piece 127, the reproduction of the present digest image data piece is replaced with the reproduction of a digest image data piece in the group next to the group having the present digest image data piece. Therefore, it is easy to implement the replacement of the reproduction of the present digest image data piece with the reproduction of the same-group main image data piece or the next-group digest image data piece.

Each digest image data piece in the recording medium 40 includes the link information 121a, and indicates the starting time 122 and the ending time 123 defining the effective term for the link information 121a. The link information 121a contains the compulsory information 125 which enables the reproduction of the present digest image data piece to be replaced with the reproduction of the next-group digest image data piece in the event that neither the first button information piece 126 nor the second button information piece 127 is selected during the effective term for the link information 121a. Therefore, the reproduction of the present digest image data can automatically be replaced with the reproduction of the next-group digest image data piece in that case.

Preferably, the reproduction controlling section 46 includes a computer having a combination of an I/O port, a CPU, a ROM, and a RAM. The data reproducing section 15, the operation unit 17, and the data reading section 41 are connected with the I/O port within the computer. The computer operates in accordance with a control program (a computer program) stored in the ROM or the RAM.

FIG. 19 is a flowchart of a segment of the control program for the computer in the reproduction controlling section 46 which is started when a command to start the reproduction (playback) of the first digest image data piece is inputted into the computer from the operation unit 17.

As shown in FIG. 19, a first step 1300 of the program segment accepts the inputted command to start the reproduction of the first digest image data piece.

A step 1310 following the step 1300 controls the data reading section 41 to read the first digest image data piece (the digest image data piece D1) from the recording medium 40. The step 1310 receives the header 121 of the first digest image data piece from the data reading section 41. Furthermore, the step 1310 controls the data reading section 41 to send the data area 120 in the first digest image data piece the data reproducing section 15. The step 1310 controls the data reproducing section 15 to reproduce the contents of the data area 120 in the first digest image data piece. This control of the data reproducing section 15 responds to the header 121 of the first digest image data piece so that the reproduction of the contents of the data area 120 of the digest image data piece D1 will be governed according to the header 121 of the first digest image data piece. The data reproducing section 15 decodes the actual video and sub-video data in the data area 120 of the digest image data piece D1 into a video signal. The step 1310 generates or derives display information from the header 121 of the digest image data piece D1. The step 1310 controls the data reproducing section 15 to add the display information to the video signal. Accordingly, every picture represented by the video signal can have not only portions originating from the actual video and sub-video data but also portions relating to or originating from the header 121 of the digest image data piece D1. The data reproducing section 15 feeds the video signal to the monitor 18. In addition, the data reproducing section 15 feeds the video signal to the external display device through the video signal outputting section 19. The monitor 18 and the external display device visualize the video signal. In other words, the monitor 18 and the external display device successively indicate pictures represented by the first digest image data piece. Thus, the contents of the first digest image data piece are reproduced (played back). Every digest picture indicated on the monitor 18 and the external display device has the first button 1420 and the second button 1430 corresponding to the first button information piece 126 and the second button information piece 127 in the header 121 of the first digest image data piece respectively. After the step 1310, the program advances to a step 1320.

The step 1320 derives the starting time 122 and the ending time 123 from the link information 121a in the header 121 of the currently-reproduced digest image data piece (the present digest image data piece). The step 1320 calculates the effective term for the link information 121a from the derived starting time 122 and the derived ending time 123. By referring to the signals from the operation unit 17, the step 1320 decides whether or not one of the buttons 1420 and 1430 is selected and the selection is decided during the calculated effective term for the link information 121a. In the case where one of the buttons 1420 and 1430 is selected and the selection is decided during the effective term for the link information 121a, the program advances from the step 1320 to a step 1330. Otherwise, the program advances from the step 1320 to a step 1380.

By referring to the signals from the operation unit 17, the step 1320 may further decide whether or not a command to stop the digest reproduction is inputted during the effective term for the link information 121a. In the case where a command to stop the digest reproduction is inputted during the effective term for the link information 121a, the program exits from the step 1320 and then the current execution cycle of the program segment ends. Otherwise, the program advances to the step 1330 or the step 1380 depending on the result of the above-mentioned decision about the button selection.

The step 1330 refers to the signals from the operation unit 17, and thereby decides whether or not the first button 1420 is selected. When the first button 1420 is selected, the program advances from the step 1330 to a step 1340. When the first button 1420 is not selected, that is, when the second button 1430 is selected, the program advances from the step 1330 to a step 1360.

The step 1340 controls the data reading section 41 and the data reproducing section 15 to suspend the reproduction of the present digest image data piece. By referring to the first button information piece 126, the step 1340 identifies main image data pieces in the group having the present digest image data piece.

A step 1350 following the step 1340 controls the data reading section 41 and the data reproducing section 15 to sequentially reproduce the identified main image data pieces from the recording medium 40. After the step 1350, the current execution cycle of the program segment ends.

The step 1360 controls the data reading section 41 and the data reproducing section 15 to suspend the reproduction of the present digest image data piece. By referring to the second button information piece 127, the step 1360 identifies a digest image data piece in the group next to the group having the present digest image data piece.

A step 1370 following the step 1360 controls the data reading section 41 and the data reproducing section 15 to reproduce the identified digest image data piece from the recording medium 40. A major part of the details of operation of the step 1370 is similar to that of the step 1310. After the step 1370, the program returns to the step 1320.

It should be noted that the steps 1320 and 1330 may be reversed to implement the following actions. A decision is made as to whether or not the first button 1420 is selected. Thereafter, a decision is made as to whether or not the moment of the selection of the first button 1420 is within the effective term for the link information 121a. A decision is made as to whether or not the second button 1430 is selected. Thereafter, a decision is made as to whether or not the moment of the selection of the second button 1430 is within the effective term for the link information 121a.

The step 1380 controls the data reading section 41 and the data reproducing section 15 to suspend the reproduction of the present digest image data piece. The step 1380 recognizes a digest image data piece identified by the compulsory information 125 in the link information 121a in the header 121 of the present digest image data piece.

A step 1390 following the step 1380 controls the data reading section 41 and the data reproducing section 15 to reproduce the identified digest image data piece from the recording medium 40. A major part of the details of operation of the step 1390 is similar to that of the step 1310. After the step 1390, the program returns to the step 1320.

### Eighth Embodiment

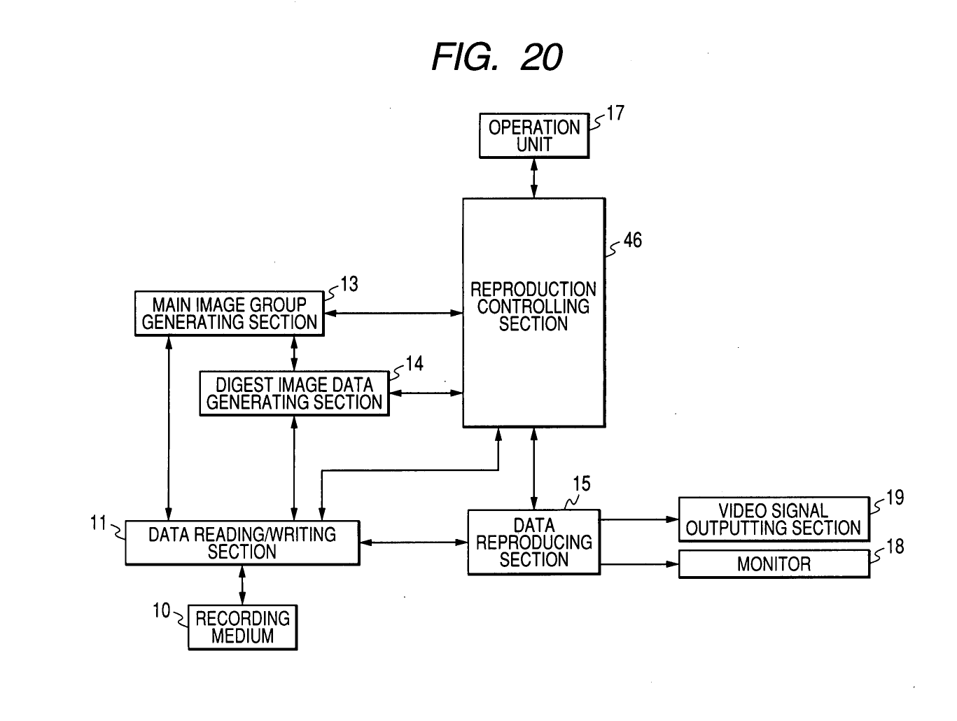

FIG. 20 shows an image data reproducing apparatus according to an eighth embodiment of this invention. The image data reproducing apparatus in FIG. 20 is similar to that in FIG. 15 except for design changes mentioned hereafter.

The image data reproducing apparatus in FIG. 20 includes a data reading/writing section 11 instead of the data reading section 41 (see FIG. 15). The data reading/writing section 11 is associated with a recording medium 10. The recording medium 10 and the data reading/writing section 11 are similar to those in FIG. 1. The image data reproducing apparatus in FIG. 20 further includes a main image group generating section 13 and a digest image data generating section 14 provided between the data reading/writing section 11 and the reproduction controlling section 46. The main image group generating section 13 and the digest image data generating section 14 are similar to those in FIG. 1.

In the image data reproducing apparatus of FIG. 20, the main image group generating section 13 implements the grouping of main image data pieces in the recording medium 10 as that in FIG. 1 does. Furthermore, the digest image data generating section 14 implements the generation of a digest image data piece for each of the groups as that in FIG. 1 does.

### Ninth Embodiment

A ninth embodiment of this invention is similar to the seventh embodiment thereof except for design changes mentioned hereafter. The ninth embodiment of this invention is designed so that the second button 1430 (see FIG. 18) will be absent from every digest picture indicated on the monitor 18 and the external display device.

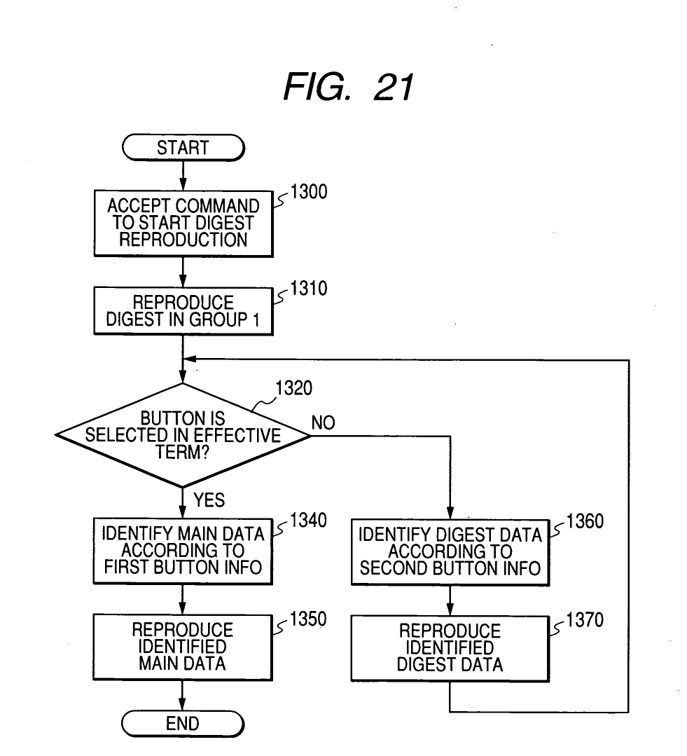

FIG. 21 is a flowchart of a segment of the control program for the computer in the reproduction controlling section 46 in the ninth embodiment of this invention. The program segment in FIG. 21 is similar to that in FIG. 19 except that the steps 1330, 1380, and 1390 are omitted.

In FIG. 21, the step 1320 decides whether or not the first button 1420 is selected and the selection is decided during the calculated effective term for the link information 121a. In the case where the first button 1420 is selected and the selection is decided during the calculated effective term for the link information 121a, the program advances from the step 1320 to the step 1340 followed by the step 1350. Otherwise, the program advances from the step 1320 to the step 1360 followed by the step 1370.

Therefore, in the case where the first button 1420 is not selected during the calculated effective term for the link information 121a, the steps 1360 and 1370 replace the reproduction of the present digest image data piece with the reproduction of a digest image data piece which is designated by the second link information piece 127 and which is in the group next to the group having the present digest image data piece.

### Tenth Embodiment

A tenth embodiment of this invention is similar to the seventh embodiment thereof except for design changes mentioned hereafter.

In the tenth embodiment of this invention, the actual sub-video data represents the color, shape, and on-screen position of each of the first and second buttons 1420 and 1430. Accordingly, the first and second buttons 1420 and 1430 in every digest picture indicated on the monitor 18 and the external display device originate from the actual sub-video data. The first button information piece 126 represents the on-screen position of the first button 1420 which is the same as that represented by the actual sub-video data. Furthermore, the first button information piece 126 represents the ID number of a main image data piece. The second button information piece 127 represents the on-screen position of the second button 1430 which is the same as that represented by the actual sub-video data. Furthermore, the second button information piece 127 represents the ID number of a next-group digest image data piece.

Thus, user's selection of one from the first and second buttons 1420 and 1430 results in a switch from the reproduction of the present digest image data piece to the reproduction of the main image data piece denoted by the first button information piece 126 or the reproduction of the next-group digest image data piece denoted by the second button information piece 127.

### Eleventh Embodiment

An eleventh embodiment of this invention is similar to the seventh embodiment thereof except for design changes mentioned hereafter.

In the eleventh embodiment of this invention, the first image data pieces are digest image data pieces while the second image data pieces are main image data pieces having portions forming the digest image data pieces. Each of the main image data pieces has a header storing link information basically similar to the link information 121a in FIG. 17.

In the eleventh embodiment of this invention, the link information is designed to implement a switch from the reproduction of the present main image data piece to the reproduction of a digest image data piece in the group having the present main image data piece in accordance with user's request. Furthermore, the link information is designed to automatically implement a switch from the reproduction of the present main image data piece to the reproduction of a main image data piece in the group next to the group having the present main image data piece in the case where user's request is absent from the effective term for the link information.

### Twelfth Embodiment

A twelfth embodiment of this invention is similar to the seventh embodiment thereof except for design changes mentioned hereafter.

The twelfth embodiment of this invention is designed so that the digest-picture frame indicated on each of the monitor 18 and the external display device is divided into first and second windows when one is selected from the first and second buttons 1420 and 1430. Then, the contents of the present digest image data piece continue to be visualized in the first window while the contents of a same-group main image data piece or a next-group digest image data piece are visualized in the second window.

What is claimed is:

1. An image data reproducing apparatus comprising:
first means for classifying main image data pieces in a recording medium into groups according to recording date and time;
second means for generating a digest image data piece from a main image data piece or pieces in each of the groups, wherein each of the generated digest image data pieces represents a digest of contents of the corresponding main image data piece or pieces; and
third means responsive to user's command for sequentially reproducing contents of the digest image data pieces, which are generated by the second means, in an order accorded with the recording dates and times of the main image data pieces corresponding to the digest image data pieces.

2. An image data reproducing apparatus comprising:
first means for classifying main image data pieces in a recording medium into groups according to recording date and time;
second means for generating a digest segment information piece designating a portion or portions of a main image data piece or pieces in each of the groups as a virtual digest image data piece; and
third means responsive to user's command for sequentially reproducing contents of the portions designated by the digest segment information pieces generated by the second means to sequentially reproduce contents of the virtual digest image data pieces in an order accorded with the recording dates and times of the main image data pieces corresponding to the virtual digest image data pieces.

3. An image data reproducing apparatus as recited in claim 1, further comprising fourth means for reproducing contents of one or ones of the main image data pieces, and fifth means responsive to user's command for replacing reproduction of contents of one of the digest image data pieces by the third means with reproduction of a main image data piece or pieces in a group corresponding to the one of the digest image data pieces by the fourth means, wherein the reproduction of the main image data pieces is in an order accorded with the recording dates and times thereof.

4. An image data reproducing apparatus as recited in claim 1, further comprising fourth means for reproducing contents of one of the main image data pieces, and fifth means responsive to user's command for replacing reproduction of one of the main image data pieces by the fourth means with reproduction of a digest image data piece corresponding to a group to which the one of the main image data pieces belongs, and other digest image data pieces by the third means, wherein the reproduction of the digest image data pieces is in an order accorded with the recording dates and times of the main image data pieces corresponding to the digest image data pieces.

5. A method of reproducing image data, comprising the steps of:
classifying main image data pieces in a recording medium into groups according to recording date and time;
generating a digest image data piece from a main image data piece or pieces in each of the groups, wherein each of the generated digest image data piece represents a digest of contents of the corresponding main image data piece or pieces; and
responsive to user's command, sequentially reproducing contents of the digest image data pieces in an order accorded with the recording dates and times of the main image data pieces corresponding to the digest image data pieces.

6. A method of reproducing image data, comprising the steps of:
classifying main image data pieces in a recording medium into groups according to recording date and time;
generating a digest segment information piece designating a portion or portions of a main image data piece or pieces in each of the groups as a virtual digest image data piece; and
responsive to user's command, sequentially reproducing contents of the portions designated by the generated digest segment information pieces to sequentially reproduce contents of the virtual digest image data pieces in an order accorded with the recording dates and times of the main image data pieces corresponding to the virtual digest image data pieces.

7. An image data reproducing apparatus comprising:
first means for reproducing first image data;
second means for reproducing second image data containing link information providing a link to the first image data; and
third means for making a switch from the reproduction of the second image data by the second means to the reproduction of the first image data by the first means in response to the link information.

8. An image data reproducing apparatus as recited in claim 7, wherein the link information represents a term for which the link information is effective, and an ID number of the first image data or an ID number of one among groups of pieces of the first image data, and wherein the link information contains button information, and further comprising a display for indicating a button in accordance with the button information, means for allowing a user to select the button indicated by the display, and means provided in the third means for making a switch from the reproduction of the second image data by the second means to the reproduction of the first image data having the ID number represented by the link information or a piece of the first image data in a group having the ID number represented by the link information in cases where the user selects the button during the term represented by the link information.

9. An image data reproducing apparatus as recited in claim 8, wherein the link information contains compulsory information representing one of (1) an ID number of the first image data, (2) an ID number of one among groups of pieces of the first image data, and (3) an ID number of one among pieces of the second image data, and further comprising means for making a switch from the reproduction of one among pieces of the second image data by the second means to reproduction of one of (1) the first image data having the ID number represented by the compulsory information, (2) a piece of the first image data in a group having the ID number represented by the compulsory information, and (3) a piece of the second image data which has the ID number represented by the compulsory information in cases where the user does not select the button during the term represented by the link information.

10. A method of reproducing image data, comprising the steps of:
a) reproducing first image data;
b) reproducing second image data containing link information providing a link to the first image data; and
c) making a switch from the reproduction of the second image data by the step b) to the reproduction of the first image data by the step a) in response to the link information.

11. A method as recited in claim 10, wherein the link information represents a term for which the link information is effective, and an ID number of the first image data or an ID number of one among groups of pieces of the first image data, and wherein the link information contains button information, and further comprising the steps of enabling a display to indicate a button in accordance with the button information, allowing a user to select the button indicated by the display, and making a switch from the reproduction of the second image data by the step b) to the reproduction of the first image data having the ID number represented by the link information or a piece of the first image data in a group having the ID number represented by the link information in cases where the user selects the button during the term represented by the link information.

12. A method as recited in claim 11, wherein the link information contains compulsory information representing one of (1) an ID number of the first image data, (2) an ID number of one among groups of pieces of the first image data, and (3) an ID number of one among pieces of the second image data, and further comprising the step of making a switch from the reproduction of one among pieces of the second image data by the step b) to reproduction of one of (1) the first image data having the ID number represented by the compulsory information, (2) a piece of the first image data in a group having the ID number represented by the compulsory information, and (3) a piece of the second image data which has the ID number represented by the compulsory information in cases where the user does not select the button during the term represented by the link information.
